(19) United States
(12) Patent Application Publication
(10) Pub. No.: US 2022/0007643 A1
(43) Pub. Date: Jan. 13, 2022

(54) NOVEL CARRIER FLUIDS FOR LIQUID FUNGAL SPORE FORMULATIONS

(71) Applicants: Bayer Aktiengesellschaft, Leverkusen (DE); Bayer CropScience Aktiengesellschaft, Monheim am Rhein (DE)

(72) Inventors: Oliver GAERTZEN, Köln (DE); Kai TEMMING, Leverkusen (DE); Roman HEUMANN, Langenfeld (DE); Ute EIBEN, Malchow/Poel (DE); Antje SEEMAN, Boiensdorf OT Stove (DE); Ulrike HILSCHER, Wismar (DE)

(21) Appl. No.: 17/261,663

(22) PCT Filed: Jul. 10, 2019
(86) PCT No.: PCT/EP2019/068483

§ 371 Date: Jan. 20, 2021

(30) Foreign Application Priority Data
Jul. 20, 2018 (EP) 18184742.7

(51) Int. Cl. A01N 37/14; A01N 63/30; A01N 25/02

(52) U.S. Cl. CPC A01N 37/14; C12R 2001/645; A01N 25/02; A01N 63/30

(57) ABSTRACT

The present invention relates to a liquid preparation comprising at least one carboxylic ester as defined and fungal spores and a method for controlling phytopathogenic fungi, insects and/or nematodes in or on a plant, for enhancing growth of a plant or for increasing plant yield or root health comprising applying an effective amount of the liquid preparation or the liquid composition according to the invention to said plant or to a locus where plants are growing or intended to be grown.

Biological control agents (BCAs) become more and more important in the area of plant protection, be it for combatting various fungal or insect pests or for improving plant health. Although also viruses are available which can be used as biological control agents, mainly BCAs based on bacteria and fungi are used in this area. The most prominent form biological control agents based on fungi are the asexual spores called conidia as well as blastospores, but also other fungal propagules may be promising agents, such as (micro)sclerotia, ascospores, basidiospores, chlamydospores or hyphal fragments.

Unlike many spores based on bacteria, such as bacillus spores, many fungal spores are less robust and it has proven to be difficult to provide fungal spores in a form which meets the needs of commercial products, in particular acceptable storage stability at certain temperatures.

The provision of suitable formulations for biological control agents nevertheless still poses a challenge due to the many factors contributing to the efficacy of the final formulation such as nature of the biological control agent, temperature stability and shelf life as well as effects of the formulation in the application.

Suitable formulations are homogeneous and stable mixtures of active and inert ingredients which make the final product simpler, safer, and more efficacious to apply to a target.

Commonly used formulations for biological control agents include WP, a solid formulation micronized to powder form and typically applied as suspended particles after dispersion in water, and WG, a formulation consisting of granules to be applied after disintegration and dispersion in water. The granules of a WG product has distinct particles within the range 0.2 to 4 mm. Water dispersible granules can be formed by agglomeration, spray drying, or extrusion techniques. WP formulations are produced rather easily but they are dusty. Further, they are not easy to dose in the field. WG formulations are easier to handle for the user and in general have lower dust content than WP formulations.

An example for a liquid formulation is SC, a water-based suspension of solid active ingredient in a fluid usually intended for dilution with water before use. Another liquid formulation type is EC, a solution of active ingredient combined with surfactants like e. g. emulsifying agents in a water insoluble organic solvent which will form an emulsion when added to water.

An enormous number of formulants have been utilized in experimental and commercial formulations of biological control agents (for a more detailed description and list see Schisler et al., Phytopathology, Vol 94, No. 11, 2004). Generally, formulants can be grouped as either carriers (fillers, extenders) or formulants that improve the chemical, physical, physiological or nutritional properties of the formulated biomass.

Stability, particularly storage stability of BCAs based on fungal actives over a longer period of time at temperatures at or above room temperature is a particular challenge due to the delicate nature of the fungal conidia. Like many living organisms, fungal conidia in their dormant state are sensible to environmental influences like e.g. water, air (oxygen), temperature, irradiation etc. Some factors may trigger germination while others may have detrimental effects to the spore viability. In order to exclude water, oils like white mineral (paraffinic) oils or vegetable oils are typically used to prepare liquid fungal spore formulations. Many of these oils provide some shelf life for fungal organisms. Vegetable oils are of natural origin and are essentially mixed carboxylic acid triglycerides composed of glycerin and C12-C18 saturated and unsaturated fatty acids; they also contain varying amounts of natural waxes. Vegetable oil compositions are variable and depend on a number of factors like plant varietals, environmental factors (e.g. soil, nutrients) and weather, to name just a few. Thus, a constant quality and composition is difficult to achieve over a number of years and/or geographies. Another limiting factor in industrial uses of vegetable oils is that all such oils are susceptible to becoming rancid, i.e. when exposed to air, light, moisture or by bacterial action this results in unpleasant odor, uncontrolled formation of polymeric residues and the release of free fatty acids that further promote decomposition in an autocatalytic way. Therefore preventative measures such as exclusion of light, oxygen, elevated temperatures and undesired microbial contamination are required and countermeasures like use of antioxidants, radical scavengers or biocides must be applied to ensure the stability of vegetable oil based compositions.

An example for a formulation of a biological control agent is described in Tones et al., 2003, J Appl Microbiol, 94(2), pp: 330-9). However, it is clear that a formulation preserving viability of the biological control agent, e. g. fungal spores, of more than 70% for 4 months at 4 degrees ° C. only is not suitable for everyday use in the field. Rather, it is desirable that formulations of biological control agents have a sufficient shelf life even under conditions where cold storage is not possible.

Kim et al., 2010 (J. S. Kim, Y. H. Je, J. Y. Roh, Journal of Industrial Microbiology & Biotechnology 2010, vol 37 (issue 4), pp, 419ff) disclose that conidia of the fungus Isaria fumosorosea show improved stability during a 2 and 8 hour heat treatment at 50° C. when dispersed in oils (Soybean, corn, cotton seed, paraffin oil, methyl oleate) in comparison to dispersion in water.

Mbarga et al., 2014 (Biological Control 2014, vol. 77, pp. 15ff) found that Trichoderma asperellum formulated in soybean oil with different emulsifiers shows improved shelf life in comparison to a dispersion of conidia in water.

Other liquids like e.g. ethoxylated trisiloxanes (e.g. Break-Thru 5240) are suitable alternatives and provide stable preparations e.g. with P. Lilacinum (BioAct®, see WO2016/050726), however manufacturing of such trisiloxanes and thus of the products themselves are expensive.

EP 1 886 570 A2 describes an agrochemically active formulation of microbial spores comprising a certain ester and a surfactant. The absolute figures for stability suggest good viabilities, however the overall stability is not particularly high as can be shown by comparing relative viabilities: spore viabilities after storage for 8 weeks at 40° C. drop to levels as low as 5.86% (Table 1, formulation 4). WO 2009/126473 A1 describes a water-based formulation containing bacteria and certain non-aqueous water-miscible and/or water-immiscible additives. WO 2016/189329 A1 describes the use of fatty acids and fatty acid derivatives in combination with certain fungal species. Begonya Vicedo et al. (Archives of Microbiology, vol. 184, no. 5, p. 316ff) describes a partially esterified carboxylic diacid (i.e. adipic acid mono ethylester, or AAME) to control diseases caused by Boytritis sp.

With the disadvantages described above there is still the need for simple, easy to handle formulation recipes for biological control agents based on fungal actives. Among other properties, such formulations shall ideally provide a good physical stability in the formulation concentrate, exhibit a suitable shelf life over time, in particular at elevated temperatures (20° C. or greater), and provide good water miscibility or suspensibility.

As discussed above, there is only very little precedence that organic fluids other than oils or organosilicones can be used to provide stable agrochemical preparations of fungal spore based BCAs. Surprisingly it was found that a large number of liquid carboxylic esters provided good to excellent spore viability after storage at elevated temperatures (5 weeks at 30° C. and beyond).

Accordingly, in a first aspect, the present invention relates to a liquid preparation comprising

at least one carboxylic ester composed of a carboxylic acid moiety and an alcohol moiety as depicted in formula I

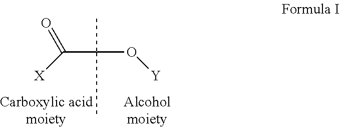

wherein said carboxylic ester is not a carboxylic acid triglyceride found in vegetable oils;
and fungal spores. The fungus should be a fungus exerting a beneficial effect on plants.

In connection with the present invention, the carboxylic ester may either be isolated from natural sources or produced by any method known in the art which is not limited to esterification of the respective carboxylic acid and alcohol underlying the carboxylic acid moiety and the alcohol moiety according to Formula I. Rather, usage of the terms “carboxylic acid moiety” and “alcohol moiety” serves to clarify and define the structure of the carboxylic esters according to the invention. When combined, both moieties create an ester group under formal elimination of H₂O. Accordingly, the carboxylic acid moiety may as well be defined as the X—(C═O)-radical of a carboxylic acid, and the alcohol moiety may be defined as the Y—O— radical of an alcohol. Such definition is also referred to as “derived from” in connection with the present invention. Preferably, the carboxylic acid underlying the carboxylic acid moiety is a carboxylic monoacid or polyacid as defined further below and the alcohol underlying the alcohol moiety is a monoalcohol or a polyalcohol as defined further below.

The carboxylic ester as used in the present invention is not a carboxylic acid triglyceride found in vegetable oils. Such carboxylic acid triglycerides comprise glycerol bound to fatty acids, wherein the term “fatty acid” relates to linear carboxylic acids having 12-18 C-atoms. Such vegetable oils comprise e.g. and preferably consist of those which are liquid at room temperature, such as corn oil, sunflower oil, soybean oil, rapeseed oil, peanut oil, cottonseed oil, rice bran oil, safflower oil, olive oil, linseed oil and castor oil. The skilled person is aware of which carboxylic acid triglycerides may be found in vegetable oils. A definition of vegetable oils may be found at https://en.wikipedia.org/wiki/Vegetable_oil (as on Jul. 20, 2018), and a summary of such carboxylic acid triglycerides may be found at http://www.dgfett.de/material/fszus.php (as on Jul. 20, 2018).

In addition to the exception above, in one embodiment, the carboxylic ester as used in the present invention, in particular the carboxylic ester according to a), is not a carboxylic acid ester composed of C14-C18 carboxylic acid moieties and an alcohol moiety based on methanol. In another embodiment, the carboxylic ester according to a) is not a carboxylic acid ester composed of C14-C18 carboxylic acid moieties and an alcohol moiety based on ethanol. In a particular embodiment the carboxylic ester according to a) is not a carboxylic acid ester composed of C14-C18 carboxylic acid moieties and an alcohol moiety based on methanol or ethanol. Such carboxylic esters are also referred to as methylated or ethylated seed oils and in some embodiments are expressly not comprised within the scope of the present invention.

Fungal spores as within the scope of the present invention comprise asexual spores called conidia as well as blastospores, but also other fungal propagules such as ascospores, basidiospores, chlamydospores. (Micro)Sclerotia, although not being spores in the strict sense, may also be added to the liquid preparation according to the invention. Preferably, the fungal spores are those of a fungus beneficial for plants as described below.

It is preferred that the fungal spores are conidia.

In one embodiment, said at least one carboxylic ester is composed of or contains or may be obtained from

a) a carboxylic monoacid moiety and a monoalcohol moiety
b) at least one carboxylic monoacid moiety and a polyalcohol moiety and/or
c) a carboxylic polyacid moiety and at least one monoalcohol moiety;
wherein said monoalcohol moiety is a branched, linear, cyclic, acyclic or partially cyclic, saturated or partially unsaturated C1-C24 monoalcohol moiety;
wherein said carboxylic monoacid moiety is a branched, linear, cyclic, acyclic or partially cyclic, saturated or partially unsaturated C2-C24 carboxylic monoacid moiety, optionally carrying at least one OH functionality;
wherein said polyalcohol moiety is a branched, linear, cyclic, acyclic or partially cyclic, saturated or partially unsaturated di-, tri-, tetra-, penta- and/or hexavalent C2-C20 polyalcohol moiety; and
wherein said at least one carboxylic polyacid moiety is a branched, linear, cyclic, acyclic or partially cyclic, saturated or partially unsaturated C2-C20 carboxylic polyacid moiety, optionally carrying at least one OH functionality.

In connection with the present invention, the term “carboxylic polyacid” comprises carboxylic acids having two or more carboxyl groups. Accordingly, within the scope of the present invention are dicarboxylic acids, tricarboxylic acids and tetracarboxylic acids.

The liquid preparation may comprise mixtures of the carboxylic esters according to any one of a) to c), e.g. a) and b), a) and c) or b) and c). Also mixtures of all three of a), b) and c) may be used.

Mixtures of any one of a) and b) can be present in ratios ranging from 1:100 to 100:1, preferably in ratios ranging from 1:50 to 50:1, more preferably in mixtures ranging from 1:25 to 25:1, such as 1:20, 1:15, 1:10, 1:5, 1:2, 1:1, 2:1, 5:1, 10:1, 15:1 or 20:1. Yet another preferred embodiment comprises mixtures of any one of a) and b) in ratios ranging from 1:20 to 1:1, or in ratios ranging from 1:1 to 20:1.

Mixtures of any one of a) and c) can be present in ratios ranging from 1:100 to 100:1, preferably in ratios ranging from 1:50 to 50:1, more preferably in mixtures ranging from 1:25 to 25:1, such as 1:20, 1:15, 1:10, 1:5, 1:2, 1:1, 2:1, 5:1, 10:1, 15:1 or 20:1. Yet another preferred embodiment comprises mixtures of any one of a) and c) in ratios ranging from 1:20 to 1:1, or in ratios ranging from 1:1 to 20:1.

Mixtures of any one of b) and c) can be present in ratios ranging from 1:100 to 100:1, preferably in ratios ranging from 1:50 to 50:1, more preferably in mixtures ranging from 1:25 to 25:1, such as 1:20, 1:15, 1:10, 1:5, 1:2, 1:1, 2:1, 5:1, 10:1, 15:1 or 20:1. Yet another preferred embodiment comprises mixtures of any one of b) and c) in ratios ranging from 1:20 to 1:1, or in ratios ranging from 1:1 to 20:1.

Mixtures of any one of a) and b) and c) can be present in ranges from either 1:1:100 to 100:100:1, or from 1:100:1 to 100:1:100, or from 100:1:1 to 1:100:100, respectively, preferably in ratios ranging from 1:1:50 to 50:50:1, or from 1:50:1 to 50:1:50, or from 50:1:1 to 1:50:50, more preferably in mixtures ranging from 1:1:25 to 25:25:1, or from 1:25:1 to 25:1:25, or from 25:1:1 to 1:25:25, such as 1:20:1, 1:15:1, 1:10:1, 1:5:1, 1:1:1, 20:1:1, 15:1:1, 10:1:1, 5:1:1, 1:1:20, 1:1:15, 1:1:10, 1:1:5, 5:20:1, 5:15:1, 5:10:1, 1:20:5, 1:15:5, 1:10:5, 20:1:5, 15:1:5, 10:1:5, 20:5:1, 15:5:1, 10:5:1, 1:5:20, 1:5:15, 1:5:10, 5:1:20, 5:1:15, or 5:1:10. Yet another preferred embodiment comprises mixtures of any one of a) and b) and c) in ratios ranging from 1:20:1 to 1:1:1, or in ratios ranging from 20:1:1 to 1:1:1, or in ratios ranging from 1:1:20 to 1:1:1.

In one embodiment, any one of a), b) and/or c) is a mixture of esters comprised of more than one different monoalcohol, polyalcohol, carboxylic monacid or carboxylic polyacid moiety. For example, the mixture according to a) may comprise more than one different carboxylic monoacid and/or monoalcohol moiety, the mixture according to b) may comprise more than one different carboxylic monoacid and/or polyalcohol moiety, and/or the mixture according to c) may comprise more than on different carboxylic polyacid and/or monoalcohol moiety.

The liquid preparation, in particular embodiments, may comprise both a mixture of different monoalcohol, polyalcohol, carboxylic monacid or carboxylic polyacid moieties as described above and a mixture of different subgroups a) to c).

In a preferred embodiment, said monoalcohol moiety is derived from a branched, linear, saturated or partially unsaturated C1-C20 monoalcohol. Exemplary and preferred monoalcohols are selected from the group consisting of methanol, ethanol, 1-propanol, 2-propanol, 1-butanol, 2-butanol, isobutanol, 1-pentanol, 1-hexanol, 1-heptanol, 2-ethylhexan-1-ol, capryl alcohol, pelargonic alcohol, isononyl alcohol, capric alcohol, undecanol, lauryl alcohol, tridecanol, isotridecanol, myristyl alcohol, pentadecanol, cetyl alcohol, palmitoleyl alcohol, heptadecanol, stearyl alcohol, oleyl alcohol, nonadecanol, eicosanol, and optionally mixtures of any of the foregoing. More preferred monoalcohols comprise methanol, ethanol, 1-propanol, 2-propanol, 1-butanol, 2-butanol, isobutanol, 1-pentanol, 1-hexanol, 1-heptanol, 2-ethylhexan-1-ol, capryl alcohol, pelargonic alcohol, isononyl alcohol, capric alcohol, lauryl alcohol, tridecanol, isotridecanol, myristyl alcohol, cetyl alcohol, palmitoleyl alcohol, stearyl alcohol, oleyl alcohol and optionally mixtures of any of the foregoing.

In another preferred embodiment, said at least one carboxylic monoacid moiety is derived from a branched, linear, saturated or partially unsaturated C2-C20 carboxylic monoacid. Exemplary and preferred carboxylic monoacids comprise acetic acid, propionic acid, butyric acid, valeric acid, caproic acid, caprylic acid, capric acid, lauric acid, myristic acid, palmitic acid, stearic acid, isostearic acid, oleic acid, linoleic acid, α-Linolenic acid, ricinolic acid and optionally mixtures of any of the foregoing.

In a preferred embodiment, the at least one polyalcohol moiety is derived from a polyalcohol selected from the group consisting of glycol, 1,3-propandiol, 1-4-butandiol, 1,5-pentandiol, 1,6-hexandiol, cyclohexan-1,2-diol, isosorbid, 1,2-propandiol, neopentylglycol, glycerol, trimethylolpropane, pentaerythritol and sugar alcohols according to the formula HOCH₂(CHOH)ₙCH₂OH (n=2, 3 or 4) and optionally mixtures thereof. Examples of sugar alcohols comprise ethylene glycol, glycerol, erythrol, threitol, arabitol, xylitol, ribitol, mannitol, sorbitol, galactitol, fucitol, iditol, inositol, volemitol, isomalt, maltitol, lactitol, maltotriol, maltotetraitol, polyglycitol and sorbitan. Preferred sugar alcohols are sorbitol and sorbitan. More preferred polyalcohols are 1,2-propandiol, neopentylglycol, glycerol, 1,3-propandiol, trimethylolpropane and sorbitan and optionally mixtures thereof. Even more preferred polyalcohols are 1,2-propandiol, glycerol, 1,3-propandiol and sorbitan and optionally mixtures thereof.

In another preferred embodiment, said at least one carboxylic polyacid moiety is derived from a carboxylic polyacid selected from the group consisting of

(i) a linear, saturated or partially unsaturated C2-C10 dicarboxylic acid
(ii) a cyclic C5-C6 dicarboxylic acid, and
(iii) citric acid and its 0-acetylated derivatives, such as 0-acetyl citric acid.

Non-limiting preferred examples of said at least one carboxylic polyacid comprise 1,2-cyclohexanedicarboxylic acid, oxalic acid, malonic acid, maleic acid, fumaric acid, succinic acid, 2-hydroxy succinic acid, glutaric acid, adipic acid, pimelic acid, O-acetyl citric acid and citric acid. As can be seen from the examples, 1,2-cyclohexanedicarboxylic acid, adipic acid, O-acetyl citric acid and glutaric acid, of which 1,2-cyclohexanedicarboxylic acid, adipic acid and O-acetyl citric acid have been successfully tested according to the present invention, are most preferred.

The at least one carboxylic monoacid or at least one carboxylic polyacid to be comprised in the carboxylic ester according to the invention may carry at least one OH functionality.

The at least one polyalcohol giving rise to the polyalcohol moiety as comprised in certain embodiments of said at least one carboxylic ester according to b) may be partially or fully esterified. In other words, the polyalcohol may be esterified at one or more of its functional OH groups up to all functional OH groups present in the resulting polyalcohol moiety. Accordingly, in a polyalcohol moiety comprising three functional OH groups, such as glycerol, one or two or all three OH groups may be esterified with a carboxylic monoacid to form a carboxylic ester according to b), and in a polyalcohol moiety comprising two functional OH groups, such as 1,3-propandiol, one or both OH groups may be esterified with a carboxylic monoacid to form a carboxylic ester according to b).

As to the carboxylic ester according to a), it is preferably composed of at least one branched, linear, saturated or partially unsaturated C2-C20 carboxylic acid moiety and at least one branched, linear, saturated or partially unsaturated C1-C20 monoalcohol moiety.

Preferably, the number of C-atoms in the carboxylic ester according to a) ranges between 13 and 28.

Preferably, the monoalcohol forming the alcohol moiety according to a) is selected from the group consisting of methanol, ethanol, 1-propanol, 2-propanol, 1-butanol, 2-butanol, isobutanol, 1-pentanol, 1-hexanol, 1-heptanol, 2-ethylhexan-1-ol, capryl alcohol, pelargonic alcohol, isononyl alcohol, capric alcohol, undecanol, lauryl alcohol, tridecanol, isotridecanol, myristyl alcohol, pentadecanol, cetyl alcohol, palmitoleyl alcohol, heptadecanol, stearyl alcohol, oleyl alcohol, nonadecanol, eicosanol and optionally mixtures of any of the foregoing.

In the carboxylic ester according to a), said carboxylic monoacid moiety is preferably derived from a carboxylic monoacid selected from the group consisting of acetic acid, propionic acid, butyric acid, valeric acid, caproic acid, caprylic acid, capric acid, lauric acid, myristic acid, palmitic acid, stearic acid, isostearic acid, oleic acid, linoleic acid, α-linolenic acid, ricinolic acid and optionally mixtures of any of the foregoing. More preferably, in particular with the carboxylic monoacids as above, the corresponding monoalcohol moiety is derived from a monoalcohol selected from the group consisting of methanol, ethanol, 1-propanol, 2-propanol, 1-butanol, 2-butanol, isobutanol, 1-pentanol, 1-hexanol, 1-heptanol, 2-ethylhexan-1-ol, capryl alcohol, pelargonic alcohol, isononyl alcohol, capric alcohol, lauryl alcohol, tridecanol, isotridecanol, myristyl alcohol, cetyl alcohol, palmitoleyl alcohol, stearyl alcohol, oleyl alcohol and optionally mixtures of any of the foregoing. In one more preferred embodiment, the methylated and/or ethylated seed oils as listed above are not comprised within the scope of the present invention.

Particularly preferred carboxylic esters according to a) comprise a carboxylic monoacid moiety derived from a carboxylic monoacid selected from the group consisting of acetic acid, propionic acid, butyric acid, valeric acid, caproic acid, caprylic acid and capric acid and optionally mixtures thereof and a monoalcohol moiety derived from a monoalcohol selected from the group consisting of lauryl alcohol, tridecanol, isotridecanol, myristyl alcohol, cetyl alcohol, palmitoleyl alcohol, stearyl alcohol, oleyl alcohol and optionally mixtures thereof.

Other particularly preferred carboxylic esters according to a) comprise a carboxylic monoacid moiety derived from a carboxylic monoacid selected from the group consisting of lauric acid, myristic acid, palmitic acid, stearic acid, oleic acid, linoleic acid, α-linolenic acid, ricinolic acid and optionally mixtures thereof, and a monoalcohol moiety derived from a monoalcohol selected from the group consisting of methanol, ethanol, 1-propanol, 2-propanol, 1-butanol, 2-butanol, isobutanol, 1-pentanol, 1-hexanol, 1-heptanol, 2-ethylhexan-1-ol, capryl alcohol, pelargonic alcohol, isononyl alcohol, capric alcohol and optionally mixtures thereof. In one more preferred embodiment, the methylated and/or ethylated seed oils as listed above are not comprised within the scope of the present invention.

As shown in the examples, carboxylic esters according to a) which are 2-ethylhexyl laurate, 2-ethylhexyl palmitate, 2-ethylhexyl oleate, ricinolic acid methylester and propionic acid pentyl ester have been shown to exert the stabilizing effect according to the invention and are thus particularly preferred.

Preferred carboxylic esters according to b) comprise a carboxylic monoacid moiety derived from a carboxylic monoacid selected from the group consisting of acetic acid, propionic acid, butyric acid, valeric acid, caproic acid, caprylic acid, capric acid, lauric acid, myristic acid, palmitic acid, stearic acid, isostearic acid, oleic acid, linoleic acid, α-linolenic acid, ricinolic acid and optionally mixtures thereof, and a poly alcohol moiety derived from a polyalcohol selected from the group consisting of 1,2-ethandiol, 1,3-propandiol, 1-4-butandiol, 1,5-pentandiol, 1,6-hexandiol, cyclohexan-1,2-diol, isosorbid, 1,2-propandiol, neopentylglycol, glycerol, pentaerythritol, trimethylolpropan, sugar alcohols and optionally mixtures thereof.

In a more preferred embodiment, in said at least one carboxylic ester according to b), said carboxylic monoacid moiety is derived from a branched, linear, cyclic, acyclic or partially cyclic, saturated or partially unsaturated C2-C6 carboxylic monoacid, optionally carrying at least one OH functionality, preferably a C2 to C5 carboxylic monoacid moiety. In this preferred embodiment, it is even more preferred that the corresponding polyalcohol moiety is derived from 1,2-propandiol, neopentylglycol, glycerol, 1,3-propandiol, trimethylolpropane and sorbitan and optionally mixtures thereof. Even more preferred polyalcohols are 1,2-propandiol, glycerol, 1,3-propandiol and sorbitan and optionally mixtures thereof.

In an alternative more preferred embodiment, in said at least one carboxylic ester according to b), said carboxylic monoacid moiety is derived from a carboxylic monoacid selected from the group consisting of acetic acid, propionic acid, butyric acid, valeric acid, caproic acid and optionally mixtures thereof, and said polyalcohol moiety is derived from a polyalcohol selected from the group consisting of neopentylglycol, pentaerythritol, trimethylolpropan and optionally mixtures thereof.

In another more preferred embodiment which may optionally combined with the embodiments immediately above the present embodiment, in said at least one carboxylic ester according to b), said polyalcohol moiety is

a cyclic or partially cyclic, saturated or partially unsaturated C2-C20-divalent, C3-C20-trivalent, C4-C20-tetravalent, C-5-C20-pentavalent or C6-C20-hexavalent polyalcohol moiety; or a polyalcohol of the following formula II

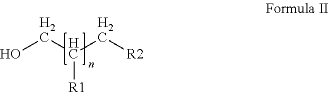

where n is an integer between 0 and 4,
where R1 and R2 are independent from each other hydrogen or hydroxy,
where R2 is C1-C9 alkyl if n=1 and R1=OH.

Alternative more preferred carboxylic esters according to b) comprise a carboxylic monoacid moiety derived from a carboxylic monoacid selected from the group consisting of acetic acid, propionic acid, butyric acid, valeric acid, caproic acid, caprylic acid, capric acid, lauric acid, myristic acid, palmitic acid, stearic acid, isostearic acid, oleic acid, linoleic acid, α-linolenic acid, ricinolic acid and optionally mixtures thereof, and a polyalcohol moiety derived from a polyalcohol selected from the group consisting of 1,2-ethandiol, 1,3-propandiol, 1-4-butandiol, 1,5-pentandiol, 1,6-hexandiol, cyclohexan-1,2-diol, isosorbid, 1,2-propandiol, glycerol, sugar alcohols and optionally mixtures thereof.

Preferably, the number of C-atoms in the carboxylic ester according to b) ranges between 9 and 60 carbon atoms, more preferably between 9 and 40.

In one particularly preferred embodiment of the carboxylic esters according to b), said polyalcohol moiety is derived from a cyclic or partially cyclic, saturated or partially unsaturated C2-C20-divalent, C3-C20-trivalent, C4-C20-tetravalent, C-5-C20-pentavalent or C6-C20-hexavalent polyalcohol. Here, it is even more preferred that said cyclic or partially cyclic polyalcohol moiety is derived from a sugar alcohol as described further above, i.e. comprising ethylene glycol, glycerol, erythrol, threitol, arabitol, xylitol, ribitol, mannitol, sorbitol, galactitol, fucitol, iditol, inositol, volemitol, isomalt, maltitol, lactitol, maltotriol, maltotetraitol, polyglycitol and sorbitan.

Particularly preferred polyalcohol moieties comprised in the carboxylic esters according to b) are derived from 1,2-ethandiol, 1,2-propandiol, neopentylglycol, 1,3-propandiol and sorbitan and optionally mixtures thereof. For example for glycerol as polyalcohol, acetic acid, propionic acid, butyric acid, valeric acid, caproic acid, caprylic acid and capric acid and optionally mixtures thereof as carboxylic monoacid to form the carboxylic acid moiety are especially preferred. For diacetylglycerol as polyalcohol, acetic acid, propionic acid, butyric acid, valeric acid, caproic acid, caprylic acid, capric acid, lauric acid, myristic acid, palmitic acid, stearic acid, isostearic acid, oleic acid, linoleic acid, α-linolenic acid and ricinolic acid and optionally mixtures thereof as carboxylic acid forming the carboxylic acid moiety are especially preferred. Another set of particularly preferred carboxylic esters according to b) are derived from neopentylglycol, trimethylolpropane and pentaerythritol polyalcohol moieties and acetic acid as carboxylic monoacid moiety.

In connection with all embodiments relating to the carboxylic esters according to b), it is generally preferred that if the polyalcohol moiety is derived from neopentylglycol, the carboxylic monoacid moiety is not derived from capric acid, and/or if the polyalcohol moiety is derived from pentaerythrol, the carboxylic monoacid moiety is not derived from 2-ethylhexanoic acid and/or if the polyalcohol moiety is derived from trimethylpropane, the carboxylic monoacid moiety is not derived from n-octadecanoic acid.

More preferably, relating to the carboxylic esters according to b), provided that the polyalcohol moiety is derived from neopentylglycol, trimethylpropane or pentaerythrol, the carboxylic acid moiety is not derived from carboxylic monoacids having 7 to 18 carbon atoms.

As shown in the examples, carboxylic esters according to b) which are propylene glycol dicaprylate, propylene glycol dicaprate, neopentylglycol dicocoate, glycerol triacetate, trimethylolpropane triisostearate, trimethylolpropane tricocoate, glycerol tricaprylate, glycerol tricaprate, C12-C18 carboxylic acid monoglyceride diacetate (C12-C18 carboxylic acids forming the group of fatty acids), trimethylolpropane tricaprylate, trimethylolpropane tricaprate, trimethylolpropane trioleate and sorbitan trioleate have been shown to exert the stabilizing effect according to the invention and are thus particularly preferred.

As to the carboxylic ester according to c), said carboxylic polyacid moiety is preferably derived from linear, saturated or partially unsaturated C2-C10 dicarboxylic acids, cyclic C5-C6 dicarboxylic acids and o-acetyl citric acid and optionally mixtures thereof. More preferably, said carboxylic polyacid moiety is derived from a carboxylic polyacid selected from the group consisting of linear, saturated C3-C8 dicarboxylic acids, 1,2-cyclohexanedicarboxylic acid and o-acetyl citric acid and optionally mixtures thereof. Even more preferably, said carboxylic polyacid moiety is derived from a carboxylic polyacid selected from the group consisting of 1,2-cyclohexanedicarboxylic acid, glutaric acid, adipic acid and 0-Acetyl citric acid and optionally mixtures thereof. In another more preferred embodiment, said carboxylic polyacid moiety is derived from a carboxylic polyacid selected from the group consisting of 1,2-cyclohexanedicarboxylic acid, glutaric acid and O-Acetyl citric acid and optionally mixtures thereof.

Preferably, the number of C-atoms in the carboxylic ester according to c) ranges between 10 and 40, more preferred between 10 and 30, and even more preferred between 10 and 20.

Alternatively or in addition to the above embodiments characterizing the carboxylic polyacid moiety in the carboxylic ester according to c), the monoalcohol moiety in the carboxylic ester according to c) is derived from a monoalcohol selected from the group consisting of methanol, ethanol, 1-propanol, 2-propanol, 1-butanol, 2-butanol, isobutanol, pentan-1-ol, pentan-2-ol, pentan-3-ol, 2-methylbutan-1-ol, 2-methylbutan-2-ol, 3-methylbutan-1-ol, 3-methylbutan-2-ol, 2,2-dimethylpropan-1-ol, 1-hexanol, 1-heptanol, 2-ethylhexan-1-ol, capryl alcohol, pelargonic alcohol, isononyl alcohol, capric alcohol, lauryl alcohol, tridecanol, isotridecanol, myristyl alcohol, cetyl alcohol, palmitoleyl alcohol, stearyl alcohol, oleyl alcohol and optionally mixtures thereof.

In one preferred embodiment of the carboxylic ester according to c), said carboxylic polyacid moiety is derived from linear C3-C8 dicarboxylic acid and the monoalcohol moiety is derived from a C1-C5 mono alcohol.

In another preferred embodiment of the carboxylic ester according to c), said carboxylic polyacid moiety is derived from cyclic dicarboxylic and tricarboxylic acids and the monoalcohol moiety is derived from a C1-C24 monoalcohol.

In all embodiments relating to the carboxylic esters according to c), it is particularly preferred that if the carboxylic polyacid moiety is derived from adipic acid, the monoalcohol moiety is not derived from isodecyl alcohol or 2-heptylundecyl alcohol. In other particularly preferred embodiment, the carboxylic esters according to c) are not derived from adipic acid and monoalcohol moieties having 6 to 18 carbon atoms.

Alternatively or in addition to the above embodiments characterizing the carboxylic esters according to c), the monoalcohol moiety in combination with linear carboxylic polyacid moieties is selected from the group consisting of methanol, ethanol, 1-propanol, 2-propanol, 1-butanol, 2-butanol and isobutanol.

As another alternative or in addition to the above embodiments characterizing the carboxylic esters according to c), the monoalcohol moiety in combination with cyclic C5-C6 dicarboxylic acids and o-acetyl citric acid or mixtures thereof is selected from the group consisting of methanol, ethanol, 1-propanol, 2-propanol, 1-butanol, 2-butanol, isobutanol, 1-hexanol, 1-heptanol, 2-ethylhexan-1-ol, capryl alcohol, pelargonic alcohol, isononyl alcohol, capric alcohol, lauryl alcohol, tridecanol, isotridecanol, myristyl alcohol, cetyl alcohol, palmitoleyl alcohol, stearyl alcohol, oleyl alcohol and optionally mixtures thereof.

As shown in the examples, carboxylic esters according to c) which are 1,2-cyclohexane dicarboxylic acid diisononyl ester, di-n-butyl adipate, diisopropyl adipate and O-acetyl citric acid tributyl ester have been shown to exert the stabilizing effect according to the invention and are thus particularly preferred.

As shown in the examples of the present application, it was found that fluids comprising carboxylic esters as described herein have a stabilizing effect according to the invention whereas other structurally similar fluids do not show this effect. Whereas Applicant does not wish to be bound by any scientific theory, it is believed that certain structural motifs of fluids such as carboxylic acid esters of low molecular weight and carboxylic acid esters providing a high solvent power are not suitable to provide a stabilizing effect. Thus, carboxylic acid esters according to a) having less than 12 carbon atoms, preferable less than 9 carbon atoms, more preferable less than 6 carbon atoms such as carboxylic acid esters derived from combinations of carboxylic acids selected from the group consisting of acetic acid, propionic acid, butyric acid, pentanoic acid or hexanoic acid with monoalcohols selected from the group consisting of methanol, ethanol, 1-propanol, 2-propanol, 1-butanol, 2-butanol, isobutanol, 1-pentanol, and 1-hexanol are not considered to be according to this invention. Non-limiting examples for carboxylic acid esters of low molecular weight not according to the invention are methyl acetate, ethyl acetate, 1-propyl acetate, 2-propyl acetate, butyl acetate, methyl propionate, ethyl propionate, propyl propionate, methyl butyrate, ethyl butyrate and methyl pentanoate. In contrast, carboxylic acid esters as defined in the claims have a stabilizing effect on fungal spores.

In the course of the present invention, it has been surprisingly found that certain liquids as defined herein are suitable to increase storage stability of fungal spores. In other words, fungal spores present in the liquid preparation according to the invention display an improved germination rate after a given time as compared to fungal spores present in a different formulation or in pure form.

In connection with the present invention, an “improved germination rate” refers to a germination rate of dormant fungal structures or organs, preferably fungal spores, which is at least 10% higher than that of dormant fungal structures or organs, such as spores not treated according to the procedure of the present invention but treated equally otherwise (“control spores”), preferably at least 20%, more preferably at least 30% or at least 40% and most preferably at least 50% higher until at least 2 weeks after production of said spores, that is after finishing the cooling period. In other words, “improved germination rate” means a germination rate of at least 110% of that of control spores, preferably at least 120%, more preferably at least 130% or at least 140% and most preferably at least 150% or higher until at least 2 weeks after production of said spores. Preferably, said improved germination rate is still visible or even increased until at least 3 months after production, more preferably at least 4 months and most preferably at least 6 months after production, such as at least 8 months, at least 10 months or even 12 months or more. Accordingly, it is preferred that the germination rate of spores treated according to the invention is at least 200% of that of control spores 3 months after production of said spores. In another preferred embodiment, the germination rate is at least 300% or at least 400%, most preferably at least 500% of that of control spores 6 months after production of said spores. The germination rate in this connection denotes the ability of spores to still germinate after a given time. % germination rate accordingly means the percentage of spores which is able to germinate after a given time. Methods of measuring the germination rate are well-known in the art. For example, spores are spread onto the surface of an agar medium, and the proportion of spores developing germ tubes is determined microscopically after incubation at appropriate growth temperatures (Oliveira et al., 2015. A protocol for determination of conidial viability of the fungal entomopathogens Beauveria bassiana and Metarhizium anisopliae from commercial products. Journal of Microbiological Methods 119; pp: 44-52, and references therein).

In a particular embodiment, the invention provides for a liquid preparation comprising

0.1-40% of fungal spores, preferred 2.5-30%, most preferred 5-25%, such as 10-20%,
up to 99.9% of at least one carboxylic ester as defined above, preferred 70 up to 97.5%, most preferred 75 up to 95%; such as 80-90%,
0-20% of surfactants (e.g. dispersants emulsifiers); preferred 0-15%, most preferred 0.1-10%;
0-10% of rheology modifiers, e.g. fumed silicas, attapulgites, preferably 0-7%, more preferably 0.5-5%;
0-5% of each antifoams, antioxidants, dyes preferred 0-3%, most preferred 0.1-0.5% of each.

In particular, it is preferred that the liquid preparation further comprises a surfactant to result in a water-miscible formulation which, after dilution with the appropriate amount of water, can be applied to the field.

BCAs are living organisms in a dormant form. Accordingly, formulations comprising a low concentration of water or even being essentially free of water are a preferred formulation type for BCAs. On the other hand, certain BCAs may also be formulated in a higher water content. If water is present, such water mainly comes from residual free water in the dried spore powder or traces of water in the other formulants. Accordingly, water concentrations of between 0 and 8% are possible due to these facts, which range would then fall within the definition of “essentially free of water”. Preferably, the water concentration ranges between 0 and 6%, more preferably between 0 and 4% such as between 2 and 4%. Accordingly, exemplary water concentrations include 2%, 3%, 4%, 5% and 6%.

Whereas it is believed that in the liquid preparation according to the invention said at least one carboxylic ester may be present in lower amount, it is preferred that it is present in an amount of at least 50 wt.-%. Generally, said at least one carboxylic ester may be present in a concentration of up to 99.9%, preferably in a range of between 70 wt.-% and 97.5 wt.-%, more preferably between 75 wt.-% and 95%, most preferably between 80 wt.-% and 90 wt.-%.

The liquid preparation according to the invention is preferably water-miscible. The term “water-miscible” indicates that said liquids are resulting in a homogeneous mixture if combined in a ratio of 1:200 of fluid and water, preferably in a ratio of 1:100, more preferably in a ratio of 1:50. In order to achieve water-miscibility, the liquid preparation preferably further comprises a surfactant as described above.

Any fungal species may be applied for the present invention. It is, however, preferred that said fungal spores are from a fungal species which has a beneficial effect on plant, such as a fungal species effective as biological control agent in plant protection or as plant health promoting agent. More preferably, said fungus is a filamentous fungus.

Filamentous fungi, as the skilled person is well aware, are distinguished from yeasts because of their tendency to grow in a multicellular, filamentous form under most conditions, in contrast to the primarily unicellular growth of oval or elliptical yeast cells.

Said at least one filamentous fungus may be any fungus exerting a positive effect on plants such as a plant protective or plant growth promoting effect. Accordingly, said fungus may be an entomopathogenic fungus, a nematophagous fungus, a plant growth promoting fungus, a fungus active against plant pathogens such as bacteria or fungal plant pathogens, or a fungus with herbicidal action.

NRRL is the abbreviation for the Agricultural Research Service Culture Collection, an international depositary authority for the purposes of deposing microorganism strains under the Budapest treaty on the international recognition of the deposit of microorganisms for the purposes of patent procedure, having the address National Center for Agricultural Utilization Research, Agricultural Research service, U.S. Department of Agriculture, 1815 North university Street, Peroira, Ill. 61604 USA.

ATCC is the abbreviation for the American Type Culture Collection, an international depositary authority for the purposes of deposing microorganism strains under the Budapest treaty on the international recognition of the deposit of microorganisms for the purposes of patent procedure, having the address ATCC Patent Depository, 10801 University Blvd., Manassas, Va. 10110 USA.

Only few fungi with selective herbicidal activity are known, such as F2.1 Phoma macrostroma, in particular strain 94-44B; F2.2 Sclerotinia minor, in particular strain IMI 344141 (e.g. Sarritor by Agrium Advanced Technologies); F2.3 Colletotrichum gloeosporioides, in particular strain ATCC 20358 (e.g. Collego (also known as LockDown) by Agricultural Research Initiatives); F2.4 Stagonospora atriplicis; or F2.5 Fusarium oxysporum, different strains of which are active against different plant species, e.g. the weed Striga hermonthica (Fusarium oxysproum formae specialis strigae).

Exemplary species of plant growth/plant health supporting, promoting or stimulating fungi are E2.1 Talaromyces flavus, in particular strain V117b; E2.2 Trichoderma atroviride, in particular strain CNCM 1-1237 (e.g. Esquive® WP from Agrauxine, FR), strain SC1 described in International Application No. PCT/IT2008/000196), strain no. V08/002387, strain no. NMI No. V08/002388, strain no. NMI No. V08/002389, strain no. NMI No. V08/002390, strain LC52 (e.g. Sentinel from Agrimm Technologies Limited), strain kd (e.g. T-Gro from Andermatt Biocontrol), and/or strain LUI32 (e.g. Tenet from Agrimm Technologies Limited); E2.3 Trichoderma harzianum, in particular strain ITEM 908 or T-22 (e.g. Trianum-P from Koppert); E2.4 Myrothecium verrucaria, in particular strain AARC-0255 (e.g. DiTera™ from Valent Biosciences); E2.5 Penicillium bilaii, in particular strain ATCC 22348 (e.g. JumpStart® from Acceleron BioAg), and/or strain ATCC20851; E2.6 Pythium oligandrum, in particular strains DV74 or M1 (ATCC 38472; e.g. Polyversum from Bioprepraty, CZ); E2.7 Rhizopogon amylopogon (e.g. comprised in Myco-Sol from Helena Chemical Company); E2.8 Rhizopogon fulvigleba (e.g. comprised in Myco-Sol from Helena Chemical Company); E2.9 Trichoderma harzianum, in particular strain TSTh20, strain KD, product Eco-T from Plant Health Products, ZA or strain 1295-22; E2.10 Trichoderma koningii; E2.11 Glomus aggregatum; E2.12 Glomus clarum; E2.13 Glomus deserticola; E2.14 Glomus etunicatum; E2.15 Glomus intraradices; E2.16 Glomus monosporum; E2.17 Glomus mosseae; E2.18 Laccaria bicolor; E2.19 Rhizopogon luteolus; E2.20 Rhizopogon tinctorus; E2.21 Rhizopogon villosulus; E2.22 Scleroderma cepa; E2.23 Suillus granulatus; E2.24 Suillus punctatapies; E2.25 Trichoderma virens, in particular strain GL-21; E2.26 Verticillium albo-atrum (formerly V. dahliae), in particular strain WCS850 (CBS 276.92; e.g. Dutch Trig from Tree Care Innovations); E2.27 Trichoderma viride, e.g. strain B35 (Pietr et al., 1993, Zesz. Nauk. A R w Szczecinie 161: 125-137) and E2.28 Purpureocillium lilacinum (previously known as Paecilomyces lilacinus) strain 251 (AGAL 89/030550; e.g. BioAct from Bayer CropScience Biologics GmbH).

In a more preferred embodiment, fungal strains having a beneficial effect on plant health and/or growth are selected from Talaromyces flavus, strain VII7b; Trichoderma harzianum strain KD or strain in product Eco-T from Plant Health Products, SZ; Myrothecium verrucaria strain AARC-0255; Penicillium bilaii strain ATCC 22348; Pythium oligandrum strain DV74 or M1 (ATCC 38472); Trichoderma viride strain B35; Trichoderma atroviride strain CNCM 1-1237, and Purpureocillium lilacinum (previously known as Paecilomyces lilacinus) strain 251 (AGAL 89/030550).

In an even more preferred embodiment, fungal strains having a beneficial effect on plant health and/or growth are selected from Penicillium bilaii strain ATCC 22348, Trichoderma viride, e.g. strain B35, Trichoderma atroviride strain CNCM 1-1237 and Purpureocillium lilacinum (previously known as Paecilomyces lilacinus) strain 251 (AGAL 89/030550).

Bactericidally active fungi are e.g.: A2.2 Aureobasidium pullulans, in particular blastospores of strain DSM14940; A2.3 Aureobasidium pullulans, in particular blastospores of strain DSM 14941 or mixtures of blastospores of strains DSM14940 and DSM14941; A2.9 Scleroderma citrinum.

Fungi active against fungal pathogens are e.g. B2.1 Coniothyrium minitans, in particular strain CON/M/91-8 (Accession No. DSM-9660; e.g. Contans® from Bayer CropScience Biologics GmbH); B2.2 Metschnikowia fructicola, in particular strain NRRL Y-30752; B2.3 Microsphaeropsis ochrace, in particular strain P130A (ATCC deposit 74412); B2.4 Muscodor albus, in particular strain QST 20799 (Accession No. NRRL 30547); B2.5 Trichoderma harzianum rifai, in particular strain KRL-AG2 (also known as strain T-22, /ATCC 208479, e.g. PLANTSHIELD T-22G, Rootshield®, and TurfShield from BioWorks, US) and strain T39 (e.g. Trichodex® from Makhteshim, US); B2.6 Arthrobotrys dactyloides; B2.7 Arthrobotrys oligospora; B2.8 Arthrobotrys superba; B2.9 Aspergillus flavus, in particular strain NRRL 21882 (e.g. Afla-Guard® from Syngenta) or strain AF36 (e.g. AF36 from Arizona Cotton Research and Protection Council, US); B2.10 Gliocladium roseum (also known as Clonostachys rosea f. rosea), in particular strain 321U from Adjuvants Plus, strain ACM941 as disclosed in Xue (Efficacy of Clonostachys rosea strain ACM941 and fungicide seed treatments for controlling the root tot complex of field pea, Can Jour Plant Sci 83(3): 519-524), strain IK726 (Jensen D F, et al. Development of a biocontrol agent for plant disease control with special emphasis on the near commercial fungal antagonist Clonostachys rosea strain ‘IK726’; Australas Plant Pathol. 2007; 36:95-101), strain 88-710 (WO2007/107000), strain CR7 (WO2015/035504) or strains CRrO, CRM and CRr2 disclosed in WO2017109802; B2.11 Phlebiopsis (or Phlebia or Peniophora) gigantea, in particular strain VRA 1835 (ATCC 90304), strain VRA 1984 (DSM16201), strain VRA 1985 (DSM16202), strain VRA 1986 (DSM16203), strain FOC PG B20/5 (IMI390096), strain FOC PG SP log 6 (IMI390097), strain FOC PG SP log 5 (IMI390098), strain FOC PG BU3 (IMI390099), strain FOC PG BU4 (IMI390100), strain FOC PG 410.3 (IMI390101), strain FOC PG 97/1062/116/1.1 (IMI390102), strain FOC PG B22/SP1287/3.1 (IMI390103), strain FOC PG SH1 (IMI390104) and/or strain FOC PG B22/SP1190/3.2 (IMI390105) (Phlebiopsis products are e.g. Rotstop® from Verdera and FIN, PG-Agromaster®, PG-Fungler®, PG-IBL®, PG-Poszwald® and Rotex® from e-nema, DE); B2.12 Pythium oligandrum, in particular strain DV74 or M1 (ATCC 38472; e.g. Polyversum from Bioprepraty, CZ); B2.13 Scleroderma citrinum; B2.14 Talaromyces flavus, in particular strain V117b; B2.15 Trichoderma asperellum, in particular strain ICC 012 from Isagro or strain SKT-1 (e.g. ECO-HOPE® from Kumiai Chemical Industry), strain T34 (e.g. ASPERELLO® from Biobest Group NV and T34 BIOCONTROL® by Biocontrol Technologies S.L., ES); B2.16 Trichoderma atroviride, in particular strain CNCM 1-1237 (e.g. Esquive® WP from Agrauxine, FR), strain SC1 described in International Application No. PCT/IT2008/000196), strain 77B (T77 from Andermatt Biocontrol), strain no. V08/002387, strain NMI no. V08/002388, strain NMI no. V08/002389, strain NMI no. V08/002390, strain LC52 (e.g. Sentinel from Agrimm Technologies Limited), strain LUI32 (e.g. Tenet by Agrimm Technologies Limited), strain ATCC 20476 (IMI 206040), strain T11 (IMI352941/CECT20498), strain SKT-1 (FERM P-16510), strain SKT-2 (FERM P-16511), strain SKT-3 (FERM P-17021); B2.17 Trichoderma harmatum; B2.18 Trichoderma harzianum, in particular, strain KD, strain T-22 (e.g. Trianum-P from Koppert), strain TH35 (e.g. Root-Pro by Mycontrol), strain DB 103 (e.g. T-Gro 7456 by Dagutat Biolab); B2.19 Trichoderma virens (also known as Gliocladium virens), in particular strain GL-21 (e.g. SoilGard by Certis, US); B2.20 Trichoderma viride, in particular strain TV1(e.g. Trianum-P by Koppert), strain B35 (Pietr et al., 1993, Zesz. Nauk. A R w Szczecinie 161: 125-137); B2.21 Ampelomyces quisqualis, in particular strain AQ 10 (e.g. AQ 100 by CBC Europe, Italy); B2.22 Arkansas fungus 18, ARF; B2.23 Aureobasidium pullulans, in particular blastospores of strain DSM14940, blastospores of strain DSM 14941 or mixtures of blastospores of strains DSM14940 and DSM 14941 (e.g. Botector® by bio-ferm, CH); B2.24 Chaetomium cupreum (e.g. BIOKUPRUM™ by AgriLife); B2.25 Chaetomium globosum (e.g. Rivadiom by Rivale); B2.26 Cladosporium cladosporioides, in particular strain H39 (by Stichting Dienst Landbouwkundig Onderzoek); B2.27 Dactylaria candida; B2.28 Dilophosphora alopecuri (e.g. Twist Fungus); B2.29 Fusarium oxysporum, in particular strain Fo47 (e.g. Fusaclean by Natural Plant Protection); B2.30 Gliocladium catenulatum (Synonym: Clonostachys rosea f catenulate), in particular strain J1446 (e.g. Prestop by Lallemand); B2.31 Lecanicillium lecanii (formerly known as Verticillium lecanii), in particular conidia of strain KV01 (e.g. Vertalec® by Koppert/Arysta); B2.32 Penicillium verniculatum; B2.33 Trichoderma gamsii (formerly T. viride), in particular strain ICC080 (IMI CC 392151 CABI, e.g. BioDerma by AGROBIOSOL DE MEXICO, S.A. DE C.V.); B2.34 Trichoderma polysporum, in particular strain IMI 206039 (e.g. Binab TF WP by BINAB Bio-Innovation AB, Sweden); B2.35 Trichoderma stromaticum (e.g. Tricovab by Ceplac, Brazil); B2.36 Tsukamurella paurometabola, in particular strain C-924 (e.g. HeberNem®); B2.37 Ulocladium oudemansii, in particular strain HRU3 (e.g. Botry-Zen® by Botry-Zen Ltd, NZ); B2.38 Verticillium albo-atrum (formerly V. dahliae), in particular strain WCS850 (CBS 276.92; e.g. Dutch Trig by Tree Care Innovations); B2.39 Muscodor roseus, in particular strain A3-5 (Accession No. NRRL 30548); B2.40 Verticillium chlamydosporium; B2.41 mixtures of Trichoderma asperellum strain ICC 012 and Trichoderma gamsii strain ICC 080 (product known as e.g. BIO-TAM™ from Bayer CropScience LP, US), B2.42 Simplicillium lanosoniveum and B2.43 Trichoderma fertile (e.g. product TrichoPlus from BASF).

In a preferred embodiment, the biological control agent having fungicidal activity is selected from Coniothyrium minitans, in particular strain CON/M/91-8 (Accession No. DSM-9660)Aspergillus flavus, strain NRRL 21882 (available as Afla-Guard® from Syngenta) and strain AF36 (available as AF36 from Arizona Cotton Research and Protection Council, US); Gliocladium roseum strain 321U, strain ACM941, strain IK726strain 88-710 (WO2007/107000), strain CR7 (WO2015/035504); Gliocladium catenulatum strain J1446; Phlebiopsis (or Phlebia or Peniophora) gigantea, in particular the strains VRA 1835 (ATCC 90304), VRA 1984 (DSM16201), VRA 1985 (DSM16202), VRA 1986 (DSM16203), FOC PG B20/5 (IMI390096), FOC PG SP log 6 (IMI390097), FOC PG SP log 5 (IMI390098), FOC PG BU3 (IMI390099), FOC PG BU4 (IMI390100), FOC PG 410.3 (IMI390101), FOC PG 97/1062/116/1.1 (IMI390102), FOC PG B22/SP1287/3.1 (IMI390103), FOC PG SH1 (IMI390104), FOC PG B22/SP1190/3.2 (IMI390105) (available as Rotstop® from Verdera and FIN, PG-Agromaster®, PG-Fungler®, PG-IBL®, PG-Poszwald®, and Rotex® from e-nema, DE); Pythium oligandrum, strain DV74 or M1 (ATCC 38472) (available as Polyversum from Bioprepraty, CZ); Talaromyces flavus, strain VII7b; Ampelomyces quisqualis, in particular strain AQ 10 (available as AQ 10® by CBC Europe, Italy); Gliocladium catenulatum (Synonym: Clonostachys rosea f. catenulate) strain J1446, Cladosporium cladosporioides, e. g. strain H39 (by Stichting Dienst Landbouwkundig Onderzoek), Trichoderma virens (also known as Gliocladium virens), in particular strain GL-21 (e.g. SoilGard by Certis, US), Trichoderma atroviride strain CNCM 1-1237, strain 77B, strain LU132 or strain SC1, having Accession No. CBS 122089, Trichoderma harzianum strain T-22 (e.g. Trianum-P from Andermatt Biocontrol or Koppert), Trichoderma asperellum strain SKT-1, having Accession No. FERM P-16510 or strain T34, Trichoderma viride strain B35 and Trichoderma asperelloides JM41R (Accession No. NRRL B-50759).

In a more preferred embodiment, the fungal species having fungicidal activity is selected from Coniothyrium minitans, in particular strain CON/M/91-8 (Accession No. DSM-9660) (available as Contans® from Prophyta, DE); Gliocladium roseum strain 321U, strain ACM941, strain IK726; Gliocladium catenulatum, in particular strain J1446; and Trichoderma virens (also known as Gliocladium virens), in particular strain GL-21. Said fungal species may also preferably be Coniothyrium minitans strain CON/M/91-8 (Accession No. DSM-9660) or Gliocladium catenulatum strain J1446 or Trichoderma atroviride strain CNCM 1-1237 or Trichoderma viride strain B35.

Within fungicidally active fungi, the genus Trichoderma, in particular the species Trichoderma viride and Trichoderma atroviride, are especially preferred. Those include Trichoderma atroviride strain CNCM 1-1237; Trichoderma atroviride strain SC1, having Accession No. CBS 122089, WO 2009/116106 and U.S. Pat. No. 8,431,120 (from Bi-PA); Trichoderma atroviride strain 77B; Trichoderma atroviride strain LU132; Trichoderma viride strain B35. Particularly preferred are Trichoderma atroviride strain CNCM 1-1237 and Trichoderma viride strain B35.

Said fungal species may be an entomopathogenic fungus.

Fungi active against insects (entomopathogenic fungi) include C2.1 Muscodor albus, in particular strain QST 20799 (Accession No. NRRL 30547); C2.2 Muscodor roseus in particular strain A3-5 (Accession No. NRRL 30548); C2.3 Beauveria bassiana, in particular strain ATCC 74040 (e.g. Naturalis® from Intrachem Bio Italia); strain GHA (Accession No. ATCC74250; e.g. BotaniGuard Es and Mycotrol-O from Laverlam International Corporation); strain ATP02 (Accession No. DSM 24665); strain PPRI 5339 (e.g. BroadBand™ from BASF); strain PPRI 7315, strain R444 (e.g. Bb-Protec from Andermatt Biocontrol), strains IL197, IL12, IL236, IL10, IL131, IL116 (all referenced in Jaronski, 2007. Use of Entomopathogenic Fungi in Biological Pest Management, 2007: ISBN: 978-81-308-0192-6), strain Bv025 (see e.g. Garcia et al. 2006. Manejo Integrado de Plagas y Agroecología (Costa Rica) No. 77); strain BaGPK; strain ICPE 279, strain CG 716 (e.g. BoveMax® from Novozymes); C2.4 Hirsutella citriformis; C2.5 Hirsutella thompsonii (e.g. Mycohit and ABTEC from Agro Bio-tech Research Centre, IN); C2.6 Lecanicillium lecanii (formerly known as Verticillium lecanii), in particular conidia of strain KV01 (e.g. Mycotal® and Vertalec® from Koppert/Arysta), strain DAOM198499 or strain DA0M216596; C2.9 Lecanicillium muscarium (formerly Verticillium lecanii), in particular strain VE 6/CABI(=IMI) 268317/CBS102071/ARSEF5128 (e.g. Mycotal from Koppert); C2.10 Metarhizium anisopliae var acridum, e.g. ARSEF324 from GreenGuard by Becker Underwood, US or isolate IMI 330189 (ARSEF7486; e.g. Green Muscle by Biological Control Products); C2.11 Metarhizium brunneum, e.g. strain Cb 15 (e.g. ATTRACAP® from BIOCARE); C2.12 Metarhizium anisopliae, e.g. strain ESALQ 1037 (e.g. from Metarril® SP Organic), strain E-9 (e.g. from Metarril® SP Organic), strain M206077, strain C4-B (NRRL 30905), strain ESC1, strain 15013-1 (NRRL 67073), strain 3213-1 (NRRL 67074), strain C20091, strain C20092, strain F52 (DSM3884/ATCC 90448; e.g. BIO 1020 by Bayer CropScience and also e.g. Met52 by Novozymes) or strain ICIPE 78; C2.15 Metarhizium robertsii 23013-3 (NRRL 67075); C2.13 Nomuraea rileyi; C2.14 Paecilomyces fumosoroseus (new: Isaria fumosorosea), in particular strains Apopka 97 (available as PreFeRal from Certis, USA), Fe9901 (available as NoFly from Natural industries, USA), ARSEF 3581, ARSEF 3302, ARSEF 2679 (ARS Collection of Entomopathogenic Fungal Cultures, Ithaca, USA), IfB01 (China Center for Type Culture Collection CCTCC M2012400), ESALQ1296, ESALQ1364, ESALQ1409 (ESALQ: University of Sao Paulo (Piracicaba, SP, Brazil)), CG1228 (EMBRAPA Genetic Resources and Biotechnology (Brasilia, DF, Brazil)), KCH J2 (Dymarska et al., 2017; PLoS one 12(10)): e0184885), HIB-19, HIB-23, HIB-29, HIB-30 (Gandarilla-Pacheco et al., 2018; Rev Argent Microbiol 50: 81-89), CHE-CNRCB 304, EH-511/3 (Flores-Villegas et al., 2016; Parasites & Vectors 2016 9:176 doi: 10.1186/s13071-016-1453-1), CHE-CNRCB 303, CHE-CNRCB 305, CHE-CNRCB 307 (Gallou et al., 2016; fungal biology 120 (2016) 414-423), EH-506/3, EH-503/3, EH-520/3, PFCAM, MBP, PSMB1 (National Center for Biololgical Control, Mexico; Castellanos-Moguel et al., 2013; Revista Mexicana De Micologia 38: 23-33, 2013), RCEF3304 (Meng et al., 2015; Genet Mol Biol. 2015 July-September; 38(3): 381-389), PF01-N10 (CCTCC No. M207088), CCM 8367 (Czech Collection of Microorganisms, Brno), SFP-198 (Kim et al., 2010; Wiley Online: DOI 10.1002/ps.2020), K3 (Yanagawa et al., 2015; J Chem Ecol. 2015; 41(12): 118-1126), CLO 55 (Ansari Ali et al., 2011; PLoS One. 2011; 6(1): e16108. DOI: 10.1371/journal.pone.0016108), IfTS01, IfTS02, IfTS07 (Dong et al. 2016/PLoS ONE 11(5): e0156087. doi:10.1371/journal.pone.0156087), P1 (Sun Agro Biotech Research Centre, India), If-02, If-2.3, If-03 (Farooq and Freed, 2016; DOI: 10.1016/j.bjm.2016.06.002), Ifr AsC (Meyer et al., 2008; J. Invertebr. Pathol. 99:96-102. 10.1016/j.jip.2008.03.007), PC-013 (DSMZ 26931), P43A, PCC (Carrillo-Pérez et al., 2012; DOI 10.1007/s11274-012-1184-1), Pf04, Pf59, Pf109 (KimJun et al., 2013; Mycobiology 2013 December; 41(4): 221-224), FG340 (Han et al., 2014; DOI: 10.5941/MYCO.2014.42.4.385), Pfrl, Pfr8, Pfr9, Pfr10, Pfr11, Pfr12 (Angel-Sahagún et al., 2005; Journal of Insect Science), Ifr531 (Daniel and Wyss, 2009; DOI 10.1111/j.1439-0418.2009.01410.x), IF-1106 (Insect Ecology and Biocontrol Laboratory, Shanxi Agricultural University), 19602, 17284 (Hussain et al. 2016, DOI:10.3390/ijms17091518), 103011 (U.S. Pat. No. 4,618,578), CNRCB1 (Centro Nacional de Referencia de Control Biologico (CNRCB), Colima, Mexico), SCAU-IFCF01 (Nian et al., 2015; DOI: 10.1002/ps.3977), PF01-N4 (Engineering Research Center of Biological Control, SCAU, Guangzhou, P. R. China) Pfr-612 (Institute of Biotechnology (IB—FCB-UANL), Mexico), Pf-Tim, Pf-Tiz, Pf-Hal, Pf-Tic (Chan-Cupul et al. 2013, DOI: 10.5897/AJMR12.493); C2.15 Aschersonia aleyrodis; C2.16 Beauveria brongniartii (e.g. Beaupro from Andermatt Biocontrol AG); C2.17 Conidiobolus obscurus; C2.18 Entomophthora virulenta (e.g. Vektor from Ecomic); C2.19 Lagenidium giganteum; C2.20 Metarhizium flavoviride; C2.21 Mucor haemelis (e.g. BioAvard from Indore Biotech Inputs & Research); C2.22 Pandora delphacis; C2.23 Sporothrix insectorum (e.g. Sporothrix Es from Biocerto, BR); and C2.24 Zoophtora radicans.

In a preferred embodiment, fungal strains having an insecticidal effect are selected from C2.3 Beauveria bassiana strain ATCC 74040; strain GHA (Accession No. ATCC74250); strain ATP02 (Accession No. DSM 24665); strain PPRI 5339; strain PPRI 7315, strain R444, strains IL197, IL12, IL236, IL10, IL131, IL116; strain BaGPK; strain ICPE 279, strain CG 716; C2.6 Lecanicillium lecanii (formerly known as Verticillium lecanii), in particular conidia of strain KV01, strain DAOM198499 or strain DAOM216596; C2.9 Lecanicillium muscarium (formerly Verticillium lecanii) strain VE 6/CABI(=IMI) 268317/CBS102071/ARSEF5128; C2.10 Metarhizium anisopliae var acridum strain ARSEF324 or isolate IMI 330189 (ARSEF7486); C2.11 Metarhizium brunneum strain Cb 15; C2.12 Metarhizium anisopliae strain ESALQ 1037, strain E-9, strain M206077, strain C4-B (NRRL 30905), strain ESC1, strain 15013-1 (NRRL 67073), strain 3213-1 (NRRL 67074), strain C20091, strain C20092, strain F52 (DSM3884/ATCC 90448) or strain ICIPE 78; C2.14 Paecilomyces fumosoroseus (new: Isaria fumosorosea) strain Apopka 97, Fe9901, ARSEF 3581, ARSEF 3302, ARSEF 2679, IfB01 (China Center for Type Culture Collection CCTCC M2012400), ESALQ1296, ESALQ1364, ESALQ1409, CG1228, KCH J2, HIB-19, HIB-23, HIB-29, HIB-30, CHE-CNRCB 304, EH-511/3, CHE-CNRCB 303, CHE-CNRCB 305, CHE-CNRCB 307, EH-506/3, EH-503/3, EH-520/3, PFCAM, MBP, PSMB1, RCEF3304, PF01-N10 (CCTCC No. M207088), CCM 8367, SFP-198, K3, CLO 55, IfTS01, IfTS02, IfTS07, P1, If-02, If-2.3, If-03, Ifr AsC, PC-013 (DSMZ 26931), P43A, PCC, Pf04, Pf59, Pf109, FG340, Pfrl, Pfr8, Pfr9, Pfr10, Pfr11, Pfr12, Ifr531, IF-1106, 19602, 17284, 103011 (U.S. Pat. No. 4,618,578), CNRCB1, SCAU-IFCF01, PF01-N4, Pfr-612, Pf-Tim, Pf-Tiz, Pf-Hal and Pf-Tic; and C2.16 Beauveria brongniartii (e.g. Beaupro from Andermatt Biocontrol AG).

In a more preferred embodiment, fungal strains having an insecticidal effect are selected from C2.3 Beauveria bassiana strain ATCC 74040; strain GHA (Accession No. ATCC74250); strain ATP02 (Accession No. DSM 24665); strain PPRI 5339; strain PPRI 7315 and/or strain R444; C2.6 Lecanicillium lecanii (formerly known as Verticillium lecanii), conidia of strain KV01, strain DAOM198499 or strain DAOM216596; C2.9 Lecanicillium muscarium (formerly Verticillium lecanii), in particular strain VE 6/CABI(=IMI) 268317/CBS102071/ARSEF5128; C2.10 Metarhizium anisopliae var acridum strain ARSEF324 or isolate IMI 330189 (ARSEF7486); C2.11 Metarhizium brunneum strain Cb 15; C2.12 Metarhizium anisopliae strain strain F52 (DSM3884/ATCC 90448); C2.14 Paecilomyces fumosoroseus (new: Isaria fumosorosea) strain Apopka 97 and Fe9901, and C2.16 Beauveria brongniartii (e.g. Beaupro from Andermatt Biocontrol AG).

It is even more preferred that said fungal microorganism is a strain of the species Isaria fumosorosea. Preferred strains of Isaria fumosorosea are selected from the group consisting of Apopka 97, Fe9901, ARSEF 3581, ARSEF 3302, ARSEF 2679, IfB01 (China Center for Type Culture Collection CCTCC M2012400), ESALQ1296, ESALQ1364, ESALQ1409, CG1228, KCH J2, HIB-19, HIB-23, HIB-29, HIB-30, CHE-CNRCB 304, EH-511/3, CHE-CNRCB 303, CHE-CNRCB 305, CHE-CNRCB 307, EH-506/3, EH-503/3, EH-520/3, PFCAM, MBP, PSMB1, RCEF3304, PF01-N10 (CCTCC No. M207088), CCM 8367, SFP-198, K3, CLO 55, IfTS01, IfTS02, IfTS07, P1, If-02, If-2.3, If-03, Ifr AsC, PC-013 (DSMZ 26931), P43A, PCC, Pf04, Pf59, Pf109, FG340, Pfrl, Pfr8, Pfr9, Pfr10, Pfr11, Pfr12, Ifr531, IF-1106, 19602, 17284, 103011 (U.S. Pat. No. 4,618,578), CNRCB1, SCAU-IFCF01, PF01-N4, Pfr-612, Pf-Tim, Pf-Tiz, Pf-Hal, Pf-Tic.

It is most preferred that said Isaria fumosorosea strain is selected from Apopka 97 and Fe9901. A particularly preferred strain is APOPKA97.

Also particularly preferred are entomopathogenic fungi of the genus Metarhizium spp. The genus Metahrizium comprises several species some of which have recently been re-classified (for an overview, see Bischoff et al., 2009; Mycologia 101 (4): 512-530). Members of the genus Metarhizium comprise M. pingshaense, M. anisopliae, M. robertsii, M. brunneum (these four are also referred to as Metarhizium anisopliae complex), M. acridum, M. majus, M. guizouense, M. Lepidiotae, M. Globosum and M. rileyi (previously known as Nomuraea rileyi). Of these, M. anisopliae, M. robertsii, M. brunneum, M. acridum and M. rileyi are even more preferred, whereas those of M. brunneum are most preferred.

Exemplary strains belonging to Metarhizium spp. which are also especially preferred are Metarhizium acridum ARSEF324 (product GreenGuard by BASF) or isolate IMI 330189 (ARSEF7486; e.g. Green Muscle by Biological Control Products); Metarhizium brunneum strain Cb 15 (e.g. ATTRACAP® from BIOCARE), or strain F52 (DSM3884/ATCC 90448; e.g. BIO 1020 by Bayer CropScience and also e.g. Met52 by Novozymes); Metarhizium anisopliae complex strains strain ESALQ 1037 or strain ESALQ E-9 (both from Metarril® WP Organic), strain M206077, strain C4-B (NRRL 30905), strain ESC1, strain 15013-1 (NRRL 67073), strain 3213-1 (NRRL 67074), strain C20091, strain C20092, or strain ICIPE 78. Most preferred are isolate F52 (a.k.a. Met52) which primarily infects beetle larvae and which was originally developed for control of Otiorhynchus sulcatus. and ARSEF324 which is commercially used in locust control. Commercial products based on the F52 isolate are subcultures of the individual isolate F52 and are represented in several culture collections including: Julius Kühn-Institute for Biological Control (previously the BBA), Darmstadt, Germany: [as M.a. 43]; HRI, UK: [275-86 (acronyms V275 or KVL 275)]; KVL Denmark [KVL 99-112 (Ma 275 or V 275)]; Bayer, Germany [DSM 3884]; ATCC, USA [ATCC 90448]; USDA, Ithaca, USA [ARSEF 1095]. Granular and emulsifiable concentrate formulations based on this isolate have been developed by several companies and registered in the EU and North America (US and Canada) for use against black vine weevil in nursery ornamentals and soft fruit, other Coleoptera, western flower thrips in greenhouse ornamentals and chinch bugs in turf.

Beauveria bassiana is mass-produced and used to manage a wide variety of insect pests including whiteflies, thrips, aphids and weevils. Preferred strains of Beauveria bassiana include strain ATCC 74040; strain GHA (Accession No. ATCC74250); strain ATP02 (Accession No. DSM 24665); strain PPRI 5339; strain PPRI 7315, strains IL197, IL12, IL236, IL10, IL131, IL116, strain Bv025; strain BaGPK; strain ICPE 279, strain CG 716; ESALQPL63, ESALQ447 and ESALQ1432, CG1229, IMI389521, NPP111B005, Bb-147. It is most preferred that Beauveria bassiana strains include strain ATCC 74040 and strain GHA (Accession No. ATCC74250). The liquid preparation according to any one of claims 1 to 17, wherein said fungal species is a nematicidally active fungus.

Nematicidally active fungal species include D2.1 Muscodor albus, in particular strain QST 20799 (Accession No. NRRL 30547); D2.2 Muscodor roseus, in particular strain A3-5 (Accession No. NRRL 30548); D2.3 Purpureocillium lilacinum (previously known as Paecilomyces lilacinus), in particular P. lilacinum strain 251 (AGAL 89/030550; e.g. BioAct from Bayer CropScience Biologics GmbH), strain 580 (BIOSTAT® WP (ATCC No. 38740) by Laverlam), strain in the product BIO-NEMATON® (T.Stanes and Company Ltd.), strain in the product MYSIS® (Varsha Bioscience and Technology India Pvt Ltd.), strain in the product BIOICONEMA® (Nico Orgo Maures, India), strain in the product NEMAT® (Ballagro Agro Tecnologia Ltda, Brazil), and a strain in the product SPECTRUM PAE L® (Promotora Tecnica Industrial, S.A. DE C.V., Mexico); D2.4 Trichoderma koningii; D2.5 Harposporium anguillullae; D2.6 Hirsutella minnesotensis; D2.7 Monacrosporium cionopagum; D2.8 Monacrosporium psychrophilum; D2.9 Myrothecium verrucaria, in particular strain AARC-0255 (e.g. DiTera™ by Valent Biosciences); D2.10 Paecilomyces variotii, strain Q-09 (e.g. Nemaquim® from Quimia, MX); D2.11 Stagonospora phaseoli (e.g. from Syngenta); D2.12 Trichoderma lignorum, in particular strain TL-0601 (e.g. Mycotric from Futureco Bioscience, ES); D2.13 Fusarium solani, strain Fs5; D2.14 Hirsutella rhossiliensis; D2.15 Monacrosporium drechsleri; D2.16 Monacrosporium gephyropagum; D2.17 Nematoctonus geogenius; D2.18 Nematoctonus leiosporus; D2.19 Neocosmospora vasinfecta; D2.20 Paraglomus sp, in particular Paraglomus brasilianum; D2.21 Pochonia chlamydosporia (also known as Vercillium chlamydosporium), in particular var. catenulata (IMI SD 187; e.g. KlamiC from The National Center of Animal and Plant Health (CENSA), CU); D2.22 Stagonospora heteroderae; D2.23 Meristacrum asterospermum, and D2.24 Duddingtonia flagrans.

In a more preferred embodiment, fungal strains with nematicidal effect are selected from Purpureocillium lilacinum, in particular spores of P. lilacinum strain 251 (AGAL 89/030550); Harposporium anguillullae; Hirsutella minnesotensis; Monacrosporium cionopagum; Monacrosporium psychrophilum; Myrothecium verrucaria, strain AARC-0255; Paecilomyces variotii; Stagonospora phaseoli (commercially available from Syngenta); and Duddingtonia flagrans.

In an even more preferred embodiment, fungal strains with nematicidal effect are selected from Purpureocillium lilacinum, in particular spores of P. Lilacinum strain 251 (AGAL 89/030550); and Duddingtonia flagrans. Most preferably, said fungal strain with nematicidal effect is from the species Purpureocillium lilacinum, in particular P. lilacinum strain 251.

The fungal microorganism producing spores and acting as biological control agent and/or plant growth promoter is cultivated or fermented according to methods known in the art or as described in this application on an appropriate substrate, e. g. by submerged fermentation or solid-state fermentation, e. g. using a device and method as disclosed in WO2005/012478 or WO1999/057239.

Although specific fungal propagules such as microsclerotia (see e.g. Jackson and Jaronski (2009). Production of microsclerotia of the fungal entomopathogen Metarhizium anisopliae and their potential for use as a biocontrol agent for soil-inhabiting insects; Mycological Research 113, pp. 842-850) may be produced by liquid fermentation techniques, it is preferred that the dormant structures or organs according to the present invention are produced by solid-state fermentation. Solid-state fermentation techniques are well known in the art (for an overview see Gowthaman et al., 2001. Appl Mycol Biotechnol (1), p. 305-352).

After fermentation, the fungal spores may be separated from the substrate. The substrate populated with the fungal spores is dried preferably before any separation step. The microorganism or fungal spores may be dried via e. g. freeze-drying, vacuum drying or spray drying after separation. Methods for preparing dried spores are well known in the art and include fluidized bed drying, spray drying, vacuum drying and lyophilization. Conidia may be dried in 2 steps: For conidia produced by solid-state fermentation first the conidia covered culture substrate is dried before harvesting the conidia from the dried culture substrate thereby obtaining a pure conidia powder. Then the conidia powder is dried further using vacuum drying or lyophilization before storing or formulating it.

The liquid preparation according to the invention may further comprise at least one substance selected from the group of surfactants, rheology modifiers, antifoaming agents, antioxidants and dyes.

Non-ionic and/or anionic surfactants are all substances of this type which can customarily be employed in agrochemical agents. Possible nonionic surfactants are selected from the groups of polyethylene oxide-polypropylene oxide block copolymers, ethoxylated mono-, di- and/or triglycerides where ethoxylated castor oil or ethoxylated vegetable oils may be mentioned by way of example, polyethylene glycol ethers of branched or linear alcohols, reaction products of fatty acids or fatty acid alcohols with ethylene oxide and/or propylene oxide, furthermore branched or linear alkylaryl ethoxylates, where polyethylene oxide-sorbitan fatty acid esters may be mentioned by way of example. Out of the examples mentioned above selected classes can be optionally phosphated and neutralized with bases. Possible anionic surfactants are all substances of this type which can customarily be employed in agrochemical agents. Alkali metal, alkaline earth metal and ammonium salts of alkylsulphonic or alkylphosphoric acids as well as alkylarylsulphonic or alkylarylphosphoric acids are preferred. A further preferred group of anionic surfactants or dispersing aids are alkali metal, alkaline earth metal and ammonium salts of polystyrenesulphonic acids, salts of polyvinylsulphonic acids, salts of alkylnaphthalene sulphonic acids, salts of naphthalenesulphonic acid-formaldehyde condensation products, salts of condensation products of naphthalenesulphonic acid, phenolsulphonic acid and formaldehyde, and salts of lignosulphonic acid. A further preferred group of anionic surfactants or dispersing aids are alkali metal, alkaline earth metal and ammonium salts of sarcosinates or taurates. Suitable ranges of surfactants in the liquid preparation according to the invention comprise 0-20%, preferably 0-15%, more preferably 0.5-10%.

Rheology modifiers, also known as thickener, anti-caking agent, viscosity modifier or structuring agent, may be added to the present formulation, e.g. in order to prevent (irreversible) sedimentation. Rheology modifiers are preferably derived from minerals. These rheological control agents provide long term stability when the formulation is at rest or in storage. Suitable compounds are rheological modifier selected from the group consisting of hydrophobic and hydrophilic fumed and precipitated silica particles, gelling clays including bentonite, hectorite, laponite, attapulgite, sepiolite, smectite, or hydrophobically/organophilic modified bentonite. Suitable ranges of rheology modifier in the liquid preparation according to the invention comprise 0-10%, preferably 0-7%, more preferably 0.5-5%.

As far as not otherwise defined, % in the present application refers to wt.-%.

In order to disperse silicas or clay thickeners in a given fluid high shear mixing is desirable to form a gel as it is known in the art.

Major global producers for fumed (pyrogenic) hydrophilic or hydrophbized silicas are Evonik (tradename Aerosil®), Cabot Corporation (tradename Cab-O-Sil®), Wacker Chemie (HDK product range), Dow Corning, and OCI (Konasil®). Another class of suitable rheology modifiers are precipitated silicas, and major global producers are Evonik (tradenames Sipernat® or Wessalon®), Rhodia (Tixosil) and PPG Industries (Hi-Sil).

Another class of suitable examples for rheology modifiers are clay thickeners. Clay thickeners are generally micronized layered silicates that can be effective thickeners for a wide range of applications. They are typically employed either in their non-hydrophobized or hydrophobized form. In order to make them dispersible in non-aqueous solvents, the clay surface is usually treated with quaternary ammonium salts. These modified clays are known as organo-modified clay thickeners. Optionally, small amounts of alcohols of low molecular weight or water may be employed as activators. Examples for such clay-based rheology modifiers include smectite, bentonite, hectorite, attapulgite, seipiolite or montmorillonite clays. Preferred rheological modifiers (b) are for example organically modified hectorite clays such as Bentone® 38 and SD3. organically modified bentonite clays, such as Bentone® 34, SD1 and SD2, organically modified sepiolite such as Pangel® B20, hydrophilic silica such as Aerosil® 200, hydrophobic silica such as Aerosil® R972, R974 and R812S, attapulgite such as Attagel® 50,

Another class of suitable examples for rheology modifiers are organic rheological modifiers based on modified hydrogentated castor oil (trihydroxystearin) or castor oil organic derivatives such as Thixcin® R and Thixatrol® ST.

Physical properties of selected rheology modifiers

| | | | Physical | |
|---|---|---|---|---|
| Tradename | Company | General description | propeties | CAS- No. |
| Bentone ® 38 | Elementis | Organic derivative of | Density: 1.7 | 12001-31-9 |
| | Specialties, US | a hectorite clay | g/cm³ | |
| Bentone ® SD-3 | Elementis | Organic derivative of | Density: 1.6 | |
| | Specialties, US | a hectorite clay | g/cm³ | |
| | | | Particle size | |
| | | | (dispersed): | |
| | | | <1 μm | |
| Bentone ® 34 | Elementis | Organic derivative of | Density: 1.7 | 68953-58-2 |
| | Specialties, US | a bentonite clay | g/cm³ | |
| Bentone ® SD-1 | Elementis | Organic derivative of | Density: 1.47 | 89749-77-9 |
| | Specialties, US | a bentonite clay | g/cm³ | |
| Bentone ® SD-2 | Elementis | Organic derivative of | Density: 1.62 | 89749-78-0 |
| | Specialties, US | a bentonite clay | g/cm³ | |
| Pangel ® B20 | Tolsa S.A., ES | Organically modified | | 63800-37-3 |
| | | sepiolite | | |
| Sipernat ® 22S | Evonik | Precipitated | *BET: 190 m²/g | 112926-00-8 |
| | Industries AG, | amorphous silicon | Average primary | |
| | DE | dioxide | particle size: 12 | |
| | | | nm | |
| Aerosil ® 200 | Evonik | Hydrophilic fumed | *BET: 200 m²/g | 112945-52-5 |
| | Industries AG, | silica | Average primary | 7631-86-9 |
| | DE | | particle size: 12 | |
| | | | nm | |
| Aerosil ® R 972/ | Evonik | Hydrophilic fumed | *BET: 90-130 | 68611-44-9 |
| R972V | Industries AG, | silica | m²/g | |
| | DE | | | |
| Aerosil ® R 974 | Evonik | Hydrophilic fumed | *BET: 150-190 | 68611-44-9 |
| | Industries AG, | silica | m²/g | |
| | DE | | | |
| Aerosil ® R | Evonik | Hydrophilic fumed | *BET: 260 ± 30 | 68909-20-6 |
| 812S | Industries AG, | silica | m²/g | |
| | DE | | | |
| Attagel ® 50 | BASF AG, DE | Attapulgite clay: | Density: >1.0 | 14808-60-7 |
| | | (Mg, Al)₅Si₈O₂₀•4H₂O | g/cm³ | |
| | | | Average particle | |
| | | | size: 9 μm | |
| Thixcin ® R | Elementis | organic derivative of | Density: 1.02 | 38264-86-7 |
| | Specialties, US | castor oil | g/cm³ | |
| Thixatrol ® ST | Elementis | organic derivative of | Density: 1.02 | 51796-19-1 |
| | Specialties, US | castor oil, | g/cm³ | |
| | | Octadecanamide | | |

In a preferred embodiment the concentration of rheological control agent is in the range of 0 to 10% wt, e. g. of 1 to 7 or 3 to 6% wt. In particular, the concentration of rheological control agent may be 0, 0.5, 1, 1.5, 2, 2.5, 3, 4, 5, 6, 7, 8 or 9% wt and essentially depends on the physical properties of the biological control agent as well as those of the carrier liquid. In general, the concentration of rheological control agent in the formulation according to the invention may also depend on the biological control agent.

Antifoaming agents may be added to the present formulation in order to prevent foaming upon dilution with water. Suitable antifoaming agents are e.g. paraffinic oils, vegetable oils, silicone oils (e.g. Silcolapse 411, Silcolapse 454, Silcolapse 482 from Solvay; Silfoam SC1132, Silfoam SC132 from Wacker; Xiameter ACP-0100 from Dow) or aqueous silicone oil emulsions (e.g. SAG30, SAG 1572/Momentive, Silcolapse 426R, Silcolapse 432/Solvay; Silfar SE4/Wacker; Antifoam 8830/Harcros Chemicals). In a preferred embodiment the concentration of antifoaming agents is in the range of 0 to 0.5 wt, e. g. of 0.1 to 0.3% wt. In particular, the concentration of antifoaming agent may be 0, 0.1, 0.2, 0.3, 0.4 or 0.5% wt or any value in between.

Antioxidants may be added to the present formulation in order to prevent or slow down oxidative degradation processes. Suitable antioxidants are e.g. tert.-Butylhydroxyquinone (TBHQ), butylhydroxytoluol (BHT), butylhydroxyanisole (BHA), ascorbyl palmitate, tocopheryl acetate, ascorbyl stearate or the group of carotinoids (e.g. beta-carotin) or gallates (e.g. ethyl gallate, propyl gallate, octyl gallate, dodecyl gallate). In a preferred embodiment the concentration of antioxidants is in the range of 0 to 0.5% wt, e. g. of 0.1 to 0.3% wt. In particular, the concentration of antioxidants may be 0, 0.1, 0.2, 0.3, 0.4 or 0.5% wt or any value in between.

Dyes which may be used include inorganic pigments, examples being iron oxide, titanium oxide and Prussian Blue, and organic dyes, such as alizarin dyes, azo dyes and metal phthalocyanine dyes.

In a different aspect, the present invention relates to a liquid composition comprising the liquid preparation according to the invention.

The present invention also relates to a method for controlling phytopathogenic fungi, insects and/or nematodes in or on a plant, for enhancing growth of a plant or for improving plant health, including plant yield or root growth comprising applying an effective amount of the liquid preparation or the liquid composition according to the invention as described above to said plant or to a locus where plants are growing or intended to be grown.

The term “plant health” generally comprises various sorts of improvements of plants that are not connected to the control of pests or phytopathogens. For example, advantageous properties that may be mentioned are improved crop characteristics including: emergence, crop yield, protein content, oil content, starch content, more developed root system, improved root growth, improved root size maintenance, improved root effectiveness, improved stress tolerance (e.g. against drought, heat, salt, UV, water, cold), reduced ethylene (reduced production and/or inhibition of reception), tittering increase, increase in plant height, bigger leaf blade, less dead basal leaves, stronger tillers, greener leaf color, pigment content, photosynthetic activity, less input needed (such as fertilizers or water), less seeds needed, more productive tillers, earlier flowering, early grain maturity, less plant verse (lodging), increased shoot growth, enhanced plant vigor, increased plant stand and early and better germination.

Improved plant health preferably refers to improved plant characteristics including: crop yield, more developed root system (improved root growth), improved root size maintenance, improved root effectiveness, tillering increase, increase in plant height, bigger leaf blade, less dead basal leaves, stronger tillers, greener leaf color, photosynthetic activity, more productive tillers, enhanced plant vigor, and increased plant stand.

With regard to the present invention, improved plant health preferably especially refers to improved plant properties selected from crop yield, more developed root system, improved root growth, improved root size maintenance, improved root effectiveness, tillering increase, and increase in plant height.

The effect of a composition according to the present invention on plant health as defined herein can be determined by comparing plants which are grown under the same environmental conditions, whereby a part of said plants is treated with a liquid preparation according to the present invention and another part of said plants is not treated with a liquid preparation according to the present invention. Instead, said other part is not treated at all or treated with a placebo (i.e., an application without a liquid preparation according to the invention such as an application without all active ingredients (i.e. without a biological control agent as described herein).

The liquid preparation according to the present invention may be applied in any desired manner, such as in the form of a seed coating, soil drench, and/or directly in-furrow and/or as a foliar spray and applied either pre-emergence, post-emergence or both. In other words, the liquid preparation can be applied to the seed, the plant or to harvested fruits and vegetables or to the soil wherein the plant is growing or wherein it is desired to grow (plant's locus of growth). Customary application methods include for example dipping, spraying, atomizing, irrigating, evaporating, dusting, fogging, broadcasting, foaming, painting, spreading-on, watering (drenching) and drip irrigating.

All plants and plant parts can be treated in accordance with the invention. Here, plants are to be understood to mean all plants and plant parts such as wanted and unwanted wild plants or crop plants (including naturally occurring crop plants),

Plants which can be treated in accordance with the invention include the following main crop plants: maize, soya bean, alfalfa, cotton, sunflower, Brassica oil seeds such as Brassica napus (e.g. canola, rapeseed), Brassica rapa, B. juncea (e.g. (field) mustard) and Brassica carinata, Arecaceae sp. (e.g. oilpalm, coconut), rice, wheat, sugar beet, sugar cane, oats, rye, barley, millet and sorghum, triticale, flax, nuts, grapes and vine and various fruit and vegetables from various botanic taxa, e.g. Rosaceae sp. (e.g. pome fruits such as apples and pears, but also stone fruits such as apricots, cherries, almonds, plums and peaches, and berry fruits such as strawberries, raspberries, red and black currant and gooseberry), Ribesioidae sp., Juglandaceae sp., Betulaceae sp., Anacardiaceae sp., Fagaceae sp., Moraceae sp., Oleaceae sp. (e.g. olive tree), Actinidaceae sp., Lauraceae sp. (e.g. avocado, cinnamon, camphor), Musaceae sp. (e.g. banana trees and plantations), Rubiaceae sp. (e.g. coffee), Theaceae sp. (e.g. tea), Sterculiceae sp., Rutaceae sp. (e.g. lemons, oranges, mandarins and grapefruit); Solanaceae sp. (e.g. tomatoes, potatoes, peppers, capsicum, aubergines, tobacco), Liliaceae sp., Compositae sp. (e.g. lettuce, artichokes and chicory—including root chicory, endive or common chicory), Umbelliferae sp. (e.g. carrots, parsley, celery and celeriac), Cucurbitaceae sp. (e.g. cucumbers—including gherkins, pumpkins, watermelons, calabashes and melons), Alliaceae sp. (e.g. leeks and onions), Cruciferae sp. (e.g. white cabbage, red cabbage, broccoli, cauliflower, Brussels sprouts, pak choi, kohlrabi, radishes, horseradish, cress and chinese cabbage), Leguminosae sp. (e.g. peanuts, peas, lentils and beans—e.g. common beans and broad beans), Chenopodiaceae sp. (e.g. Swiss chard, fodder beet, spinach, beetroot), Linaceae sp. (e.g. hemp), Cannabeacea sp. (e.g. cannabis), Malvaceae sp. (e.g. okra, cocoa), Papaveraceae (e.g. poppy), Asparagaceae (e.g. asparagus); useful plants and ornamental plants in the garden and woods including turf, lawn, grass and Stevia rebaudiana; and in each case genetically modified types of these plants.

Crop plants can be plants which can be obtained by conventional breeding and optimization methods or by biotechnological and genetic engineering methods or combinations of these methods, including the transgenic plants and including the plant varieties which can or cannot be protected by varietal property rights. Plants should be understood to mean all developmental stages, such as seeds, seedlings, young (immature) plants up to mature plants. Plant parts should be understood to mean all parts and organs of the plants above and below ground, such as shoot, leaf, flower and root, examples given being leaves, needles, stalks, stems, flowers, fruit bodies, fruits and seeds, and also tubers, roots and rhizomes. Parts of plants also include harvested plants or harvested plant parts and vegetative and generative propagation material, for example seedlings, tubers, rhizomes, cuttings and seeds.

Treatment according to the invention of the plants and plant parts with the liquid preparation or the composition comprising said liquid preparation is carried out directly or by allowing the compounds to act on the surroundings, environment or storage space by the customary treatment methods, for example by immersion, spraying, evaporation, fogging, scattering, painting on, injection and, in the case of propagation material, in particular in the case of seeds, also by applying one or more coats.

As already mentioned above, it is possible to treat all plants and their parts according to the invention. In a preferred embodiment, wild plant species and plant cultivars, or those obtained by conventional biological breeding methods, such as crossing or protoplast fusion, and also parts thereof, are treated. In a further preferred embodiment, transgenic plants and plant cultivars obtained by genetic engineering methods, if appropriate in combination with conventional methods (genetically modified organisms), and parts thereof are treated. The terms “parts” or “parts of plants” or “plant parts” have been explained above. The invention is used with particular preference to treat plants of the respective commercially customary cultivars or those that are in use. Plant cultivars are to be understood as meaning plants having new properties (“traits”) and which have been obtained by conventional breeding, by mutagenesis or by recombinant DNA techniques. They can be cultivars, varieties, bio- or genotypes.

Transgenic plants or plant cultivars (those obtained by genetic engineering) which are to be treated with preference in accordance with the invention include all plants which, through the genetic modification, received genetic material which imparts particular advantageous useful properties (“traits”) to these plants. Examples of such properties are better plant growth, increased tolerance to high or low temperatures, increased tolerance to drought or to levels of water or soil salinity, enhanced flowering performance, easier harvesting, accelerated ripening, higher yields, higher quality and/or a higher nutritional value of the harvested products, better storage life and/or processability of the harvested products. Further and particularly emphasized examples of such properties are increased resistance of the plants against animal and microbial pests, such as against insects, arachnids, nematodes, mites, slugs and snails owing, for example, to toxins formed in the plants, in particular those formed in the plants by the genetic material from Bacillus thuringiensis (for example by the genes CryIA(a), CryIA(b), CryIA(c), CryIIA, CryIIIA, CryIIIB2, Cry9c Cry2Ab, Cry3Bb and CryIF and also combinations thereof), furthermore increased resistance of the plants against phytopathogenic fungi, bacteria and/or viruses owing, for example, to systemic acquired resistance (SAR), systemin, phytoalexins, elicitors and also resistance genes and correspondingly expressed proteins and toxins, and also increased tolerance of the plants to certain herbicidally active compounds, for example imidazolinones, sulphonylureas, glyphosate or phosphinothricin (for example the “PAT” gene). The genes which impart the desired traits in question may also be present in combinations with one another in the transgenic plants. Examples of transgenic plants which may be mentioned are the important crop plants, such as cereals (wheat, rice, triticale, barley, rye, oats), maize, soya beans, potatoes, sugar beet, sugar cane, tomatoes, peas and other types of vegetable, cotton, tobacco, oilseed rape and also fruit plants (with the fruits apples, pears, citrus fruits and grapes), with particular emphasis being given to maize, soya beans, wheat, rice, potatoes, cotton, sugar cane, tobacco and oilseed rape. Traits which are particularly emphasized are the increased resistance of the plants to insects, arachnids, nematodes and slugs and snails.

Furthermore, the present invention relates to the use of the liquid preparation or the liquid composition according to the invention as plant protection agent or for promoting plant vigor and/or plant health.

The following examples illustrate the present invention in a non-limiting fashion.

### Materials

| Trade name | Chemical description | Supplier | CAS-No. | type |
|---|---|---|---|---|
| Radia 7127 | 2-Ethylhexyl laurate | Oleon | 20292-08-4 | Monoalcohol- |
| | | | | Monoacid a) |
| Radialube 7130/ | 2-Ethylhexyl oleate | Oleon | 26399-02-2 | Monoalcohol- |
| Radia 7331 | | | | Monoacid a) |
| Radia 7081 | Ricinolic acid methylester | Oleon | 141-24-2 | Monoalcohol- |
| | | | | Monoacid a) |
| Pentyl Propionate | Propionic acid Pentyl ester | Sigma- | 624-54-4 | Monoalcohol- |
| | | Aldrich | | Monoacid a) |
| Radia 7208 | Propylene glycol | Oleon | 68583-51-7 | Dialcohol- |
| | dicaprylate/caprate | | | Monoacid b) |
| Radialube 7302 | Neopentylglycol dicocoate | Oleon | 68038-32-4 | Dialcohol- |
| | | | | Monoacid b) |
| Triacetin | Glycerin triacetate | Sigma- | 102-76-1 | Trialcohol- |
| | | Aldrich | | Monoacid b) |
| Radia 7380 | Trimethylolpropane | Oleon | 68541-50-4 | Trialcohol- |
| | Triisostearate | | | Monoacid b) |
| Radialube 7359 | Trimethylolpropane | Oleon | 85566-29-6 | Trialcohol- |
| | Tricocoate | | | Monoacid b) |
| Miglyol 812 | Glycerin | Sasol | 73398-61-5 | Trialcohol- |
| | Tricaprylate/Caprate | | | Monoacid b) |
| Radia 7909 | Fatty acid monoglyceride | Oleon | | Trialcohol- |
| | diacetate | | | Monoacid b) |
| Radia 7368 | Trimethylolpropane | Oleon | 11138-60-6 | Trialcohol- |
| | Tricaprylate/Caprate | | | Monoacid b) |
| Radialube 7361 | Trimethylolpropane | Oleon | 57675-44-2 | Trialcohol- |
| | Trioleate | | | Monoacid b) |
| Radiasurf 7355 | Sorbitan trioleate | Oleon | 26266-58-0 | Polyalcohol- |
| | | | | Monoacid b) |
| Agnique AE829 | 1,2-Cyclohexane | BASF | 166412-78-8 | Monoalcohol- |
| | dicarboxylic acid | | | Diacid c) |
| | diisononyl ester | | | |
| Adimoll DB | di-n-Butyl adipate | LanXess | 105-99-7 | Monoalcohol- |
| | | | | Diacid c) |
| Crodamol DA | Diisopropyl adipate | Croda | 6938-94-9 | Monoalcohol- |
| | | | | Diacid c) |
| Acetyltributyl | O-Acetyl citric acid | Sigma- | 77-90-7 | Monoalcohol- |
| citrate | tributyl ester | Aldrich | | Triacid c) |
| MERO EC ® | Self emulsifiable esters of | Bayer AG | | comparison |
| | rapeseed oil | | | |
| Break-Thru S240 | Polyether-modified | Evonik | 134180-76-0 | comparison |
| | trisiloxane | | | |
| Catenex T121 | White mineral oil | Shell | 64742-54-7 | comparison |

### EXAMPLE I (PURPUREOCILLIUM LILACINUM)

3 g of Purpureocillium lilacinum pure spore powder were transferred into a formulation vessel (IKA Type DT-20 mixing vessel with dispersion tool for Ultra Turrax) using a sterile spoon. 12 mL of fluid were added into the respective formulation vessel and dispersed using ultra turrax tube drive control for 1 min at 3000 rpm; change direction after 30 sec. After this 2.8 mL were transferred in four sample bottles (Wheaton Serum vial, Type I) leaving little headspace and closed tight using crimpneck caps (Macherey—Nagel type N 13). Afterwards all sample bottles were transferred to an incubator set at 30° C. and stored for a given time.

In regular intervals a sample was retrieved from the storage location and analyzed for spore viability. For this purpose, the original samples were thoroughly homogenized. Aliquots of 0.25 g or 25 μL of each sample were transferred into 50 mL falcon tubes. The tubes were filled up to 25 g using a sterile aqueous solution containing 2% Tween 80 and homogenized by vortexing to achieve the first dilution step (1:100 dilution). This dilution was used for further dilution and spotting on agar.

Not all samples mixed well or mixed at all in 2% Tween 80. For these samples, an alternative dispersion/dilution method was applied where the oil phase was stripped from the spores first: 0.25 g or 250 μL of sample are weighted into a 2 mL Eppendorf tube, and 0.5 mL of 2% Tween 80 is added, and the mixture is transferred into an Eppendorf centrifuge where it is centrifuged for 1 min at 10.000 rpm. The supernatant (=upper oily phase) is discarded by using a pipette. Afterwards 250 μL of Breakthru S 240 were added and the spores were well dispersed. 250 μL or 0.25 g of each sample were transferred into a sterile 50 mL Falcon tube. The tubes were filled up to 25 g using a sterile aqueous solution containing 2% Tween 80 and homogenized by vortexing to achieve the first dilution step (1:100 dilution). This dilution was used for further dilution and spotting on agar.

For evaluation of spore germination rate prepare a 1:30000 dilution based on the 1:100 dilution achieved by multiple automated dilution (pipetting robot, 96 well plate). Afterwards 12×12 cm agar plates were taken and spotted with 10 times 54 of each sample using an automated 12-Channel pipet. Wait until liquid is soaked up by agar and transfer agar plate to an incubator and incubate at 25° C. for 17 hours. Open the plate and place it under the microscope. Randomly chose one area per spot and record the number of germinated and non-germinated spores that are within the designated field. At least 200 spores per sample need to be evaluated. If needed count more than one field per spot.

The results of spore viabilities are given in table I.

TABLE I

| | | | spore viability [%] | | | | | |
|---|---|---|---|---|---|---|---|---|
| | | Liquid | at day | after 2 w | after 1 m | after 5-6 w | after 2 m | after 3 m |
| # | Liquid | Class | 1 | (12-15 d) | (27-28 d) | (35-40 d) | (51-55 d) | (87-92 d) |
| 1 | Pentyl Propionate | a | 99.1 | | | 94.6 | | 16.1 |
| 2 | Radia 7081 | a | n/a^{#} | 94.7 | 95.8 | | 88.6 | |
| 3 | Radia 7127 | a | 99.1 | 99.0 | 98.3 | | 88.4 | 40.6* |
| 4 | Radia 7331 | a | n/a^{#} | 97.9 | 95.9 | | 85.9 | |
| 5 | Radialube 7130 | a | n/a^{#} | 98.5 | 94.3 | | 87.9 | |
| 6 | Radia 7208 | b | n/a^{#} | 95.7 | 98.3 | | 92.9 | |
| 7 | Radia 7368 | b | 98.6 | | | 96.9 | | 89.6 |
| 8 | Radia 7380 | b | | 96.5 | 89.3 | | 86.0 | |
| 9 | Radia 7909 | b | 98.1 | | | 96.5 | | 78.5 |
| 10 | Radialube 7302 | b | 99.1 | | | 94.7 | | 83.1 |
| 11 | Radialube 7359 | b | 58.0^{#} | 60.6^{#} | 87.8 | | 87.5 | 87.3* |
| 12 | Radialube 7361 | b | n/a^{#} | 97.2 | 92.3 | | 85.4 | |
| 13 | Radiasurf 7355 | b | 98.3 | | | 96.4 | | 64.1 |
| 14 | Triacetin | b | 98.3 | 97.9 | 96.2 | | 90.8 | 69.4* |
| 15 | Acetyltributylcitrat | c | 98.9 | | | 98.0 | | 87.5 |
| 16 | Adimoll DB | c | 98.9 | | | 97.5 | | 89.8 |
| 17 | Agnique AE829 | c | n/a^{#} | 97.3 | 96.5 | | 89.8 | |
| 18 | Crodamol DA | c | 98.2 | 94.3 | 95.0 | | 68.2 | 51.3* |
| 19 | Breakthru S240^{$} | | 90.5 | 91.8 | 85.8 | | 76.8 | 7.4* |
| 20 | Mero EC ®^{$} | | 93.9 | | | 89.4 | | 4.5 |

*= taken after 7 m of storage;
^{#}= difficulties to disperse in water for evaluation;
^{$}= comparative examples

Discussion: Spore viability directly after manufacturing of the samples (day 1) is generally at or above 90% for the vast majority of all fluids tested. Fluids according to the invention exhibit a spore viability of approx. 70% or greater after storage for 2 or 3 months at 30° C., respectively. Selected fluids have been stored for 7 months at 30° C. and exhibit a spore viability of approx. 40% or greater after storage (Table I, entries 3,11,14,18,19). BreakThru 5240 has been previously described as a superior fluid to host fungal spores. For comparison, BreakThru 5240 (Table I, entry 19) provides ˜77% spore viability after 2m of storage and approx. 7% after 7m of storage under the given test conditions. Mero EC® (Table I, entry 20), which is a tankmix additive that serves as a comparative example for self-emulsifying methylated seed oils, exhibited only a marginal spore viability of approx. 5% after 3m of storage.

### EXAMPLE II (ISARIA FUMOSOROSEA)

1.5 g of I. fumosorosea pure spore powder were transferred into a formulation vessel (IKA Type DT-20 mixing vessel with dispersion tool for Ultra Turrax) using a sterile spoon. 13.5 mL of fluid were added into the respective formulation vessel and dispersed using ultra turrax tube drive control for 1 min at 3000 rpm; change direction after 30 sec. After this 2.8 mL were transferred in four sample bottles (Wheaton Serum vial, Type I) leaving little headspace and closed tight using crimpneck caps (Macherey—Nagel type N 13) Afterwards all sample bottles were transferred to an incubator set at 30° C. and stored for a given time.

In regular intervals a sample was retrieved from the storage location and analyzed for spore viability. Therefore the original samples were thoroughly homogenized. Aliquots of 0.25 g or 25 μL of each sample were transferred into 50 mL falcon tubes. The tubes were filled up to 25 g using a sterile aqueous solution containing 2% Tween 80 and homogenized by vortexing to achieve the first dilution step (1:100 dilution). This dilution was used for further dilution and spotting on agar.

Not all samples mixed well or mixed at all in 2% Tween 80. For these samples, an alternative dispersion/dilution method was applied where the oil phase is stripped from the spores first: 0.25 g or 250 μL of sample were weighted into a 2 mL Eppendorf tube, and 0.5 mL of 2% Tween 80 was added, and the mixture was transferred into an Eppendorf centrifuge where it was centrifuged for 1 min at 10.000 rpm. The supernatant (=upper oily phase) was discarded by using a pipette. Afterwards 250 of Breakthru S 240 were added and the spores were well dispersed. 250 μL or 0.25 g of each sample were transferred into a sterile 50 mL Falcon tube. The tubes were filled up to 25 g using a sterile aqueous solution containing 2% Tween 80 and homogenized by vortexing to achieve the first dilution step (1:100 dilution). This dilution was used for further dilution and spotting on agar.

For evaluation of spore germination rate prepare a 1:15000 dilution based on the 1:100 dilution achieved by multiple automated dilution (pipetting robot, 96 well plate). Afterwards 12×12 cm agar plates are taken and spotted with 10 times 54 of each sample using an automated 12-Channel pipet. Wait until liquid is soaked up by agar and transfer agar plate to an incubator and incubate at 23° C. for 16 hours. Open the plate and place it under the microscope. Randomly chose one area per spot and record the number of germinated and non-germinated spores that are within the designated field. At least 200 spores per sample need to be evaluated. If needed count more than one field per spot. The results of spore viabilities are given in table II.

TABLE II

spore viability [%]

| | | | after 1 m | after 7 m |
|---|---|---|---|---|
| # | Liquid | at day 1 | (27 d) | (210 d) |
| 1 | Catenex T 121^{$} | 91.8 | 60.5 | 64.2 |
| 2 | Adimoll DB | 89.5 | 66.6 | 60.0 |
| 3 | Triacetin | 90 | 84.0 | 69.1 |
| 4 | Breakthru S240^{$} | 90.9 | 78.7 | 69.6 |

^{$}= comparative examples

### Discussion:

Spore viability directly after manufacturing of the spores (day 1) is generally around 90% for all fluids tested. Fluids according to the invention exhibit a spore viability of approx. 60% or greater after storage for 7m at 30° C. (Table II, entries 2,3) and thus equal the performance level of the comparison examples, i.e. BreakThru 5240 and Catenex T 121 (Table 2 entries 1, 4).

### EXAMPLE III (BEAUVERIA BASSIANA)

1.5 g of Beauveria bassiana pure spore powder were transferred into a formulation vessel (IKA Type DT-20 mixing vessel with dispersion tool for Ultra Turrax) using a sterile spoon. 13.5 mL of fluid were added into the respective formulation vessel and dispersed using ultra turrax tube drive control for 1 min at 3000 rpm; change direction after 30 sec. After this 2.8 mL were transferred in four sample bottles (Wheaton Serum vial, Type I) leaving little headspace and closed tight using crimpneck caps (Macherey—Nagel type N 13) Afterwards all sample bottles were transferred to an incubator set at 30° C. and stored for a given time.

In regular intervals a sample was retrieved from the storage location and analyzed for spore viability. Therefore the original samples were thoroughly homogenized. Aliquots of 0.25 g or 25 μL of each sample are transferred into 50 mL falcon tubes. The tubes were filled up to 25 g using a sterile aqueous solution containing 2% Tween 80 and homogenized by vortexing to achieve the first dilution step (1:100 dilution). This dilution was used for further dilution and spotting on agar.

Not all samples mixed well or mixed at all in 2% Tween 80. For these samples, an alternative dispersion/dilution method was applied where the oil phase is stripped from the spores first: 0.25 g or 250 μL of sample are weighted into a 2 mL Eppendorf tube, and 0.5 mL of 2% Tween 80 is added, and the mixture is transferred into an Eppendorf centrifuge where it is centrifuged for 1 min at 10.000 rpm. The supernatant (=upper oily phase) is discarded by using a pipette. Afterwards 250 μL of Breakthru S 240 are added and the spores are well dispersed. 250 μL or 0.25 g of each sample are transferred into a sterile 50 mL Falcon tube. The tubes were filled up to 25 g using a sterile aqueous solution containing 2% Tween 80 and homogenized by vortexing to achieve the first dilution step (1:100 dilution). This dilution is used for further dilution and spotting on agar.

For evaluation of spore germination rate prepare a 1:15000 dilution based on the 1:100 dilution achieved by multiple automated dilution (pipetting robot, 96 well plate). Afterwards 12×12 cm agar plates are taken and spotted with 10 times 5 μL of each sample using an automated 12-Channel pipet. Wait until liquid is soaked up by agar and transfer agar plate to an incubator and incubate at 20° C. for 17 hours. Open the plate and place it under the microscope. Randomly chose one area per spot and record the number of germinated and non-germinated spores that are within the designated field. At least 200 spores per sample need to be evaluated. If needed count more than one field per spot. The results of spore viabilities are given in Table III.

TABLE III

spore viability [%]

| | | at day | after 2 w | after 5 w |
|---|---|---|---|---|
| # | Liquid | 1 | (14 d) | (35 d) |
| 1 | Radia 7127 | 91.3 | 76.3 | 68.4 |
| 2 | Radia 7331 | 91.5 | 81.4 | 66.3 |
| 3 | Adimoll DB | 87 | 66.1 | 37.7 |
| 4 | Agnique AE829 | 89.7 | 74.9 | 57.8 |
| 5 | Radialube 7302 | 84.2 | 68.4 | 52.7 |
| 6 | Radiasurf 7355 | n/a^{#} | 71.3 | 60.4 |
| 7 | Radia 7208 | 86.9 | 66.8 | 52.7 |
| 8 | Radia 7368 | 90.6 | 80.8* | |
| 9 | Triacetin | 89.3 | 58.6 | 31.6 |
| 10 | Radia 7909 | 75.1 | 11.5 | 18.1 |
| 11 | Acetyltributylcitrat | 85.5 | 76.7 | 58.8 |
| 12 | Miglyol 812 | 90.9 | 74.1 | 49.0 |
| 13 | Breakthru S240^{$} | 53.1 | 27.6 | 19.6 |

*= taken after 21 d of storage;
^{#}= difficulties to disperse in water for evaluation;
^{$}= comparative example

Discussion: Spore viability directly after manufacturing of the samples (day 1) is generally high and in most cases at or above 75%, in many cases even close to or above 90% under the given test conditions Among the examples according to the invention are selected fluids that exhibit a spore viability of approx. 30% or greater after storage for 5w or longer at 30° C. Many fluids even provide a spore viability of ˜50% or greater, in some cases even ˜60% or greater (Table III, entries 1, 2, 4, 6, 11) For comparison, BreakThru 5240 provides only approx. 53% spore viability at day 1 and approx. 20% after 5w of storage (Table III, entry 13).

### EXAMPLE IV: PENICILLIUM BILAII

1.5 g of Penicillium bilaii pure spore powder were transferred into a formulation vessel (IKA Type DT-20 mixing vessel with dispersion tool for Ultra Turrax) using a sterile spoon. 13.5 mL of fluid were added into the respective formulation vessel and dispersed using ultra turrax tube drive control for 1 min at 3000 rpm; change direction after 30 sec. After this 2.8 mL were transferred in four sample bottles (Wheaton Serum vial, Type I) leaving little headspace and closed tight using crimpneck caps (Macherey—Nagel type N 13) Afterwards all sample bottles were transferred to an incubator set at 30° C. and stored for a given time.

In regular intervals a sample was retrieved from the storage location and analyzed for spore viability. Therefore the original samples were thoroughly homogenized. Aliquots of 0.25 g or 25 μL of each sample are transferred into 50 mL falcon tubes. The tubes were filled up to 25 g using a sterile aqueous solution containing 2% Tween 80 and homogenized by vortexing to achieve the first dilution step (1:100 dilution). This dilution was used for further dilution and spotting on agar.

Not all samples mixed well or mixed at all in 2% Tween 80. For these samples, an alternative dispersion/dilution method was applied where the oil phase is stripped from the spores first: 0.25 g or 250 μL of sample are weighted into a 2 mL Eppendorf tube, and 0.5 mL of 2% Tween 80 is added, and the mixture is transferred into an Eppendorf centrifuge where it is centrifuged for 1 min at 10.000 rpm. The supernatant (=upper oily phase) is discarded by using a pipette. Afterwards 250 μL of Breakthru S 240 are added and the spores are well dispersed. 250 μL or 0.25 g of each sample are transferred into a sterile 50 mL Falcon tube. The tubes were filled up to 25 g using a sterile aqueous solution containing 2% Tween 80 and homogenized by vortexing to achieve the first dilution step (1:100 dilution). This dilution is used for further dilution and spotting on agar.

For evaluation of spore germination rate prepare a 1:15000 dilution based on the 1:100 dilution achieved by multiple automated dilution (pipetting robot, 96 well plate). Afterwards 12×12 cm agar plates are taken and spotted with 10 times 54 of each sample using an automated 12-Channel pipet. Wait until liquid is soaked up by agar and transfer agar plate to an incubator and incubate at 20° C. for 17 hours. Open the plate and place it under the microscope. Randomly chose one area per spot and record the number of germinated and non-germinated spores that are within the designated field. At least 200 spores per sample need to be evaluated. If needed count more than one field per spot. The results of spore viabilities are given in Table IV.

TABLE IV

| | | spore viability [%] | | |
|---|---|---|---|---|
| | | initial | 6 w@30° C. | 3 m@30° C. |
| No | Liquid | (1-2 d) | (41-43 d) | (83-85 d) |
| 1 | Acetyltributylcitrat | 98.4 | 83.8 | 60.6 |
| 2 | Adimoll DB | 97.5 | 90.8 | 75.5 |
| 3 | Breakthru S240^{$} | 61.3 | 38.5 | 20.2 |
| 4 | Agnique AE829 | 95.3 | 89.4 | 71.9 |
| 5 | Radia 7127 | 97.1 | 96 | 77.9 |
| 6 | Radia 7208 | 92.6 | 91.7 | 75.9 |
| 7 | Radia 7331 | 97.1 | 91.4 | 75.7 |
| 8 | Radia 7368 | 98.1 | 91.6 | 74.4 |
| 9 | Radia 7909 | 90.6 | 75.6 | 42.0 |
| 10 | Radialube 7302 | 94.5 | 86.1 | 70.2 |
| 11 | Triacetin | 92.9 | 83.2 | 57.6 |

^{$}= comparative example

Discussion: Spore viability directly after manufacturing of the samples (day 1) is generally high and at or above 90%. Examples according to the invention exhibit a spore viability of approx. 42% or greater after storage for approx. 3 months at 30° C. In many cases the fluids are exhibiting an even higher spore viability of approx. 70% or higher (Table IV, entries 2, 4-8, 10). For comparison, Break-Thru 5240 provides only 20% of spore viability after storage under conditions given here (Table IV entry 3).

1. A liquid preparation comprising at least one carboxylic ester composed of a carboxylic acid moiety and an alcohol moiety
wherein said carboxylic ester is not a carboxylic acid triglyceride from vegetable oils, and fungal spores of a fungus exerting a beneficial effect on plants,
wherein said at least one carboxylic ester contains
a) a carboxylic monoacid moiety and a monoalcohol moiety
b) at least one carboxylic monoacid moiety and a polyalcohol moiety or
c) a carboxylic polyacid moiety and at least one monoalcohol moiety;
wherein said monoalcohol moiety is a branched, linear, cyclic, acyclic or partially cyclic, saturated or partially unsaturated C1-C24 monoalcohol moiety;
wherein said carboxylic monoacid moiety is a branched, linear, cyclic, acyclic or partially cyclic, saturated or partially unsaturated C2-C24 carboxylic monoacid moiety, optionally carrying at least one OH functionality;
wherein said polyalcohol moiety is a branched, linear, cyclic, acyclic or partially cyclic, saturated or partially unsaturated di-, tri-, tetra-, penta- or hexavalent C2-C20 polyalcohol moiety; and
wherein said carboxylic polyacid moiety is a branched, linear, cyclic, acyclic or partially cyclic, saturated or partially unsaturated C2-C20 carboxylic polyacid moiety.

2. The liquid preparation according to claim 1, wherein any one of a), b) and/or c) is a mixture of esters comprised of more than one different monoalcohol moiety, polyalcohol moiety, carboxylic monacid moiety or carboxylic polyacid moiety.

3. The liquid preparation according to claim 1, comprising a mixture of carboxylic esters according to any one of a) to c).

4. The liquid preparation according to claim 1, wherein said monoalcohol moiety is derived from a branched, linear, saturated or partially unsaturated C1-C20 monoalcohol selected from the group consisting of methanol, ethanol, 1-propanol, 2-propanol, 1-butanol, 2-butanol, isobutanol, 1-pentanol, 1-hexanol, 1-heptanol, 2-ethylhexan-1-ol, capryl alcohol, pelargonic alcohol, isononyl alcohol, capric alcohol, undecanol, lauryl alcohol, tridecanol, isotridecanol, myristyl alcohol, pentadecanol, cetyl alcohol, palmitoleyl alcohol, heptadecanol, stearyl alcohol, oleyl alcohol, nonadecanol, eicosanol, and mixtures thereof.

5-6. (canceled)

7. The liquid preparation according to claim 1, wherein said at least one carboxylic monoacid moiety is derived from a branched, linear, saturated or partially unsaturated C2-C20 carboxylic acid selected from the group consisting of acetic acid, propionic acid, butyric acid, valeric acid, caproic acid, caprylic acid, capric acid, lauric acid, myristic acid, palmitic acid, stearic acid, isostearic acid, oleic acid, linoleic acid, α-linolenic acid, ricinolic acid and mixtures thereof.

8. (canceled)

9. The liquid preparation according to claim 1, wherein said at least one polyalcohol moiety is derived from a polyalcohol selected from the group consisting of glycol, 1,3-propandiol, 1-4-butandiol, 1,5-pentandiol, 1,6-hexandiol, cyclohexan-1,2-diol, isosorbid, 1,2-propandiol, neopentylglycol, glycerol, trimethylolpropane, pentaerythritol and sugar alcohols.

10. (canceled)

11. The liquid preparation according to claim 1, wherein said at least one carboxylic polyacid moiety is derived from a carboxylic polyacid selected from the group consisting of
(a) a linear, saturated or partially unsaturated C2-C10 dicarboxylic acid
(b) a cyclic C5-C6 dicarboxylic acid, and
(c) citric acid and its O-acylated derivatives, such as 0-acetyl citric acid.

12-13. (canceled)

14. The liquid preparation according to claim 1, wherein said at least one carboxylic monoacid moiety or at least one carboxylic polyacid moiety carries at least one OH functionality.

15. The liquid preparation according to claim 1, wherein said at least one polyalcohol moiety of said at least one carboxylic ester according to b) is partially or fully esterified.

16. (canceled)

17. The liquid preparation according to claim 1, wherein said at least one carboxylic ester according to a) comprises between 13 and 28 carbon atoms.

18. The liquid preparation according to claim 1, wherein said carboxylic monoacid moiety is derived from a carboxylic monoacid selected from the group consisting of acetic acid, propionic acid, butyric acid, valeric acid, caproic acid, caprylic acid, capric acid, lauric acid, myristic acid, palmitic acid, stearic acid, isostearic acid, oleic acid, linoleic acid, α-linolenic acid, ricinolic acid and mixtures thereof.

19. The liquid preparation according to claim 18, wherein said monoalcohol moiety is derived from a monoalcohol selected from the group consisting of methanol, ethanol, 1-propanol, 2-propanol, 1-butanol, 2-butanol, isobutanol, 1-pentanol, 1-hexanol, 1-heptanol, 2-ethylhexan-1-ol, capryl alcohol, pelargonic alcohol, isononyl alcohol, capric alcohol, lauryl alcohol, tridecanol, isotridecanol, myristyl alcohol, cetyl alcohol, palmitoleyl alcohol, stearyl alcohol, oleyl alcohol and mixtures thereof.

20-21. (canceled)

22. The liquid preparation according to claim 1, wherein said carboxylic ester is selected from the group consisting of 2-ethylhexyl laurate, 2-ethylhexyl palmitate, 2-ethylhexyl oleate, ricinolic acid methylester and propionic acid pentyl ester.

23. The liquid preparation according to claim 1, wherein in said at least one carboxylic ester according to b), said carboxylic monoacid moiety is derived from a carboxylic monoacid selected from the group consisting of acetic acid, propionic acid, butyric acid, valeric acid, caproic acid, caprylic acid, capric acid, lauric acid, myristic acid, palmitic acid, stearic acid, isostearic acid, oleic acid, linoleic acid, α-linolenic acid and ricinolic acid and said polyalcohol moiety is derived from a polyalcohol selected from the group consisting of 1,2-ethandiol, 1,3-propandiol, 1-4-butandiol, 1,5-pentandiol, 1,6-hexandiol, cyclohexan-1,2-diol, isosorbid, 1,2-propandiol, neopentylglycol, glycerol, pentaerythritol, trimethylolpropan and sugar alcohols.

24. The liquid preparation according to claim 1, wherein in said at least one carboxylic ester according to b), said carboxylic monoacid moiety is a branched, linear, cyclic, acyclic or partially cyclic, saturated or partially unsaturated C2-C6 carboxylic monoacid moiety, optionally carrying at least one OH functionality, preferably a C2 to C5 carboxylic monoacid moiety.

25. The liquid preparation according to claim 1, wherein in said at least one carboxylic ester according to b), said polyalcohol moiety is
a cyclic or partially cyclic, saturated or partially unsaturated C2-C20-divalent, C3-C20-trivalent, C4-C20-tetravalent, C-5-C20-pentavalent or C6-C20-hexavalent polyalcohol moiety; or
a polyalcohol of the following formula II 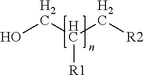
where n is an integer between 0 and 4,
where R1 and R2 are independent from each other hydrogen or hydroxy,
where R2 is C1-C9 alkyl if n=1 and R1=OH
wherein said cyclic or partially cyclic, saturated or partially unsaturated C2-C20-divalent, C3-C20-trivalent, C4-C20-tetravalent, C-5-C20-pentavalent or C6-C20-hexavalent polyalcohol moiety is derived from a sugar alcohol and
wherein said sugar alcohol is selected from the group consisting of ethylene glycol, propylene glycol, glycerol, erythrol, threitol, arabitol, xylitol, ribitol, mannitol, sorbitol, galactitol, fucitol, iditol, inositol, volemitol, isomalt, maltitol, lactitol, maltotriol, maltotetraitol, polyglycitol and sorbitan.

26-28. (canceled)

29. The liquid preparation according to claim 23, wherein said polyalcohol is glycerol and said carboxylic monoacid is selected from the group consisting of acetic acid, propionic acid, butyric acid, valeric acid, caproic acid, caprylic acid and/or capric acid or mixtures thereof.

30. The liquid preparation according to claim 23, wherein said carboxylic ester is composed of diacetylglycerol esterified with acetic acid, propionic acid, butyric acid, valeric acid, caproic acid, caprylic acid, capric acid, lauric acid, myristic acid, palmitic acid, stearic acid, isostearic acid, oleic acid, linoleic acid, α-linolenic acid and ricinolic acid.

31. The liquid preparation according to claim 1, wherein said carboxylic ester is selected from the group consisting of proplylene glycol dicaprylate, propylene glycol dicaprate, neopentylglycol dicocoate, glycerol triacetate, trimethylolpropane triisostearate, trimethylolpropane tricocoate, glycerol tricaprylate, glycerol tricaprate, C12-C18 carboxylic acid monoglyceride diacetate, trimethylolpropane tricaprylate, trimethylolpropane tricaprate, trimethylolpropane trioleate and sorbitan trioleate.

32. The liquid preparation according to claim 1, wherein in said at least one carboxylic ester according to c), said carboxylic polyacid moiety is derived from linear, saturated or partially unsaturated C2-C10 dicarboxylic acids, cyclic C5-C6 dicarboxylic acids, citric acid and its 0-acetylated derivatives and wherein said monoalcohol moiety is derived from a monoalcohol selected from the group consisting of methanol, ethanol, 1-propanol, 2-propanol, 1-butanol, 2-butanol, isobutanol, pentan-1-ol, pentan-2-ol, pentan-3-ol, 2-methylbutan-1-ol, 2-methylbutan-2-ol, 3-methylbutan-1-ol, 3-methylbutan-2-ol, 2,2-dimethylpropan-1-ol, 1-hexanol, 1-heptanol, 2-ethylhexan-1-ol, capryl alcohol, pelargonic alcohol, isononyl alcohol, capric alcohol, lauryl alcohol, tridecanol, isotridecanol, myristyl alcohol, cetyl alcohol, palmitoleyl alcohol, stearyl alcohol and oleyl alcohol.

33-36. (canceled)

37. The liquid preparation according to claim 1, wherein said fungal spores are from a fungal species which is effective as biological control agent in plant protection or plant health promoting agent.

38. The liquid preparation according to claim 37, wherein said fungal species is an entomopathogenic fungus selected from the group consisting of Isaria fumosorosea, Penicillium bilaii, Metarhizium anisopliae, Purpureocillium lilacinum, Coniothyrium minitans, Beauveria bassiana and Clonostachys rosea.

39-40. (canceled)

41. The liquid preparation according to claim 1, further comprising at least one substance selected from the group consisting of surfactants, rheology modifiers, antifoaming agents, antioxidants and dyes.

42. A liquid composition comprising the liquid preparation according to claim 1.

43. A method for controlling phytopathogenic fungi, insects and/or nematodes in or on a plant, for enhancing growth of a plant or for increasing plant yield or root health comprising applying an effective amount of the liquid preparation of claim 1 to said plant or to a locus where plants are growing or intended to be grown.

44. (canceled)
